(19) United States
(12) Patent Application Publication
(10) Pub. No.: US 2024/0386541 A1
(43) Pub. Date: Nov. 21, 2024

(54) SELF-INTEGRATING INSPECTION LINE SYSTEM

(71) Applicant: Kitov Systems Ltd, Petach Tikva (IL)

(72) Inventor: Joseph RUBNER, Shoham (IL)

(73) Assignee: Kitov Systems Ltd, Petach Tikva (IL)

(21) Appl. No.: 18/694,035

(22) PCT Filed: Sep. 23, 2022
(86) PCT No.: PCT/IL2022/051022

§ 371 Date: Mar. 21, 2024

Related U.S. Application Data
(60) Provisional application No. 63/247,381, filed on Sep. 23, 2021.

(51) Int. Cl. G06T 7/00; G06T 7/70; G06V 10/98

(52) U.S. Cl. CPC G06T 7/0004; G06T 7/70; G06V 10/993; G06T 2207/30108

(57) ABSTRACT

Image outputs of visual inspection resources are integrated into a visual inspection plan for a manufactured item. Imaging requirements are accessed, derived from visual inspection requirements for the manufactured item. Also accessed are imaging parameters specifying configurations of respective visual inspection resources used to generate visual inspection images of the manufactured item. Correspondences between imaging requirements and imaging parameters and/or images are determined. From these correspondences, fulfilment of the inspection requirements is determined. Tasks such as inspection planning, reporting, and/or modification of configurations of visual inspection resources are optionally carried out, based on the fulfilment determinations.

### RELATED APPLICATIONS

This application claims the benefit of priority of U.S. Provisional Patent Application No. 63/247,381 filed Sep. 23, 2021, the contents of which are incorporated herein by reference in their entirety.

### FIELD AND BACKGROUND OF THE INVENTION

The present invention, in some embodiments thereof, relates to the field of quality inspection and more particularly, but not exclusively, to automated visual quality inspection.

Manufactured items typically comprise a plurality of components of various types and appearances. Since defects related, e.g., to forming, assembly, and/or finishing may occur in manufacturing processes, quality inspection processes are typically introduced into production so that product quality can be confirmed, maintained, and/or improved.

Methods for performing automated quality inspection of manufactured items typically comprise machine-implemented tests (inspection procedures) intended to confirm that actual details of a particular instance of a manufactured item correspond to corresponding expectations.

U.S. Patent Publication No. 2019/0213724 A1, the contents of which are included herein by reference in their entirety, describes systems and methods for automated inspection, including the generation of an inspection plan based on the inspection model and the one or more analysis parameters.

International Patent Publication No. WO/2019/156783 A1, the contents of which are included herein by reference in their entirety, describes systems and methods for automated part enrollment. The process of enrollment helps to specify inspection tests, and/or baseline models to which quality inspection results may be compared.

### SUMMARY OF THE INVENTION

According to an aspect of some embodiments of the present disclosure, there is provided a method of integrating image outputs of pre-configured visual inspection resources into a visual inspection plan for an inspected item, the method including: accessing, by a computer: one or more imaging requirements derived from visual inspection requirements for the inspected item, and imaging parameters specifying configurations of respective pre-configured visual inspection resources used to generate visual inspection images of the inspected item; determining correspondences between the imaging requirements and the imaging parameters, each correspondence being established by: a visual inspection image produced according to the imaging parameters shows an inspection target which is a portion of the inspected item, and the inspection target is shown as specified by at least one of the imaging requirements; estimating, using the correspondences, fulfilment of the imaging requirements by visual inspection images generated using the imaging parameters; and generating a visual inspection plan fulfilling the visual inspection requirements, the visual inspection plan including the use of visual inspection images generated using the pre-configured visual inspection resources according to their respective pre-configurations.

According to some embodiments of the present disclosure, the determining correspondences includes determination that: imaging parameters for a visual inspection image specify a camera pose relative to the inspected item; and the camera pose matches a camera pose defined by at least one of the imaging requirements.

According to some embodiments of the present disclosure, the determining correspondences includes analyzing visual inspection images generated according to the specifying imaging parameters.

According to some embodiments of the present disclosure, the analyzing includes mapping features of the visual inspection images to corresponding features of a 3-D model of the inspected item.

According to some embodiments of the present disclosure, each of the visual inspection requirements specifies: at least one component to be inspected and a visual inspection procedure testing the at least one component; and the imaging requirements specify images of the at least one component used in the visual inspection procedure.

According to some embodiments of the present disclosure, the one or more imaging requirements each respectively specify at least one camera viewing angle of the inspected item; the imaging parameters of each configuration respectively specify at least one camera viewing angle of the inspected item; and the estimating includes comparing camera viewing angles of the configurations to camera viewing angles of the imaging requirements.

According to some embodiments of the present disclosure, the estimating includes determining if the camera viewing angles of the configurations are within ranges defined by the camera viewing angles of the imaging requirements.

According to some embodiments of the present disclosure, the method includes categorizing the visual inspection requirements by the computer, based on the estimating by the computer; and providing the categorizations.

According to some embodiments of the present disclosure, the categorizing includes identifying one or more of the visual inspection requirements as having none of the imaging requirements of its imaging requirement set fulfilled.

According to some embodiments of the present disclosure, the categorizing includes identifying one or more of the visual inspection requirements as having all of the image input requirements of its image input requirement set fulfilled.

According to some embodiments of the present disclosure, the categorizing includes identifying a visual inspection requirement as having image input requirements of its image input requirement set partially fulfilled.

According to some embodiments of the present disclosure, the method includes providing a specification of imaging parameters for additional visual inspection images of the inspected item that would complete fulfilment of the image input requirement set.

According to some embodiments of the present disclosure, the method includes: accessing one or more first images from visual inspection images generated using the one or more imaging parameter sets, and which are images that partially fulfill the image input requirements of the image input requirement set; accessing one or more second images from the additional visual inspection images; and automatically analyzing the first and second images to fulfill the visual inspection requirement.

According to some embodiments of the present disclosure, the generating includes generating an inspection plan specifying collection by a robotic imaging system of at least one additional visual inspection image, to complete fulfilment of at least one of the image input requirement sets.

According to some embodiments of the present disclosure, the method includes providing a specification of imaging parameters for inspection images that would complete fulfilment of at least one of the image input requirement sets.

According to some embodiments of the present disclosure, the imaging parameters define configurations of one or more fixed-position cameras.

According to some embodiments of the present disclosure, the imaging parameters define configurations of one or more cameras preconfigured to move along a predefined path.

According to some embodiments of the present disclosure, the estimating includes: accessing at least one image from visual inspection images generated using the one or more imaging parameter sets; automatically analyzing the at least one image according to a visual inspection requirement; evaluating validity of a result of the automatic analyzing; and producing an estimate of the fulfilment of the imaging requirement depending on the validity of the result of the automatic analyzing.

According to some embodiments of the present disclosure, an invalid result corresponds to an estimate of non-fulfilment of the visual inspection requirement's respective image input requirement set.

According to an aspect of some embodiments of the present disclosure, there is provided a method of integrating image outputs of visual inspection resources into a visual inspection plan for an inspected item, the method including: accessing, by a computer: one or more imaging requirements derived from visual inspection requirements for the inspected item, and images of the inspected item obtained by visual inspection resources; determining correspondences between the imaging requirements and the images, each correspondence being established by: an image shows an inspection target which is a portion of the inspected item, and the inspection target is shown in the image as specified by at least one of the imaging requirements; selecting images potentially useful for fulfilling at least one of the visual inspection requirements, using the correspondences; using the selected images, calculating results of automated visual inspection procedures configured to fulfill the visual inspection requirements; estimating utility of the selected images in fulfilling the visual inspection requirements, using the calculated results; and generating, guided by the estimated utility of the selected images, a visual inspection plan fulfilling the visual inspection requirements, the visual inspection plan including the use of visual inspection images generated according to imaging parameters used to generate at least one of the selected images, and estimated to be useful in fulfilling the visual inspection requirements.

According to some embodiments of the present disclosure, the determined correspondences comprise determination that: imaging parameters for a visual inspection image specify a camera pose relative to the inspected item; and the camera pose matches a camera pose defined by at least one of the imaging requirements.

According to some embodiments of the present disclosure, the determining correspondences includes analyzing visual inspection images generated according to the specifying imaging parameters.

According to some embodiments of the present disclosure, the analyzing includes mapping features of the visual inspection images to corresponding features of a 3-D model of the inspected item.

According to some embodiments of the present disclosure, each of the visual inspection requirements specifies: at least one component to be inspected and a visual inspection procedure testing the at least one component; and the imaging requirements specify images of the at least one component used in the visual inspection procedure.

According to some embodiments of the present disclosure, the one or more imaging requirements each respectively specify at least one camera viewing angle of the inspected item; the imaging parameters of each configuration respectively specify at least one camera viewing angle of the inspected item; and the estimating includes comparing camera viewing angles of the configurations to camera viewing angles of the imaging requirements.

According to some embodiments of the present disclosure, the generating includes categorizing the visual inspection requirements by the computer according to estimates of the utility of the selected images in fulfilling the visual inspection requirements.

According to some embodiments of the present disclosure, the categorizing includes identifying at least one of the visual inspection requirements as having no corresponding image of the selected images useful for fulfilling it.

According to some embodiments of the present disclosure, the categorizing includes identifying at least one of the visual inspection requirements as being fulfilled by the automated visual inspection procedures using one or more images of the selected images.

According to some embodiments of the present disclosure, the categorizing includes identifying at least one of the visual inspection requirements as being partially fulfilled by the automated visual inspection procedures using one or more images of the selected images.

According to an aspect of some embodiments of the present disclosure, there is provided a method of integrating image outputs of pre-configured visual inspection resources into a visual inspection plan for an inspected item, the method including: accessing, by a computer: one or more imaging requirements derived from visual inspection requirements for the inspected item, and imaging parameters specifying configurations of respective visual inspection resources used to generate visual inspection images of the inspected item; determining correspondences between the imaging requirements and the imaging parameters, each correspondence being established by: a visual inspection image produced according to the imaging parameters shows an inspection target which is a portion of the inspected item, and the inspection target is shown as specified by at least one of the imaging requirements; estimating, using the correspondences, fulfilment of the imaging requirements by visual inspection images generated using the imaging parameters; and generating a visual inspection plan fulfilling the visual inspection requirements, wherein the visual inspection plan uses different visual inspection resources positioned to image components of the inspected item at different stages of assembly.

According to some embodiments of the present disclosure, the determined correspondences comprise determination that: imaging parameters for a visual inspection image specify a camera pose relative to the inspected item; and the camera pose matches a camera pose defined by at least one of the imaging requirements.

According to some embodiments of the present disclosure, the determining correspondences includes analyzing visual inspection images generated according to the specifying imaging parameters.

According to some embodiments of the present disclosure, the analyzing includes mapping features of the visual inspection images to corresponding features of a 3-D model of the inspected item.

According to some embodiments of the present disclosure, each of the visual inspection requirements specifies: at least one component to be inspected and a visual inspection procedure testing the at least one component; and the imaging requirements specify images of the at least one component used in the visual inspection procedure.

According to some embodiments of the present disclosure, the one or more imaging requirements each respectively specify at least one camera viewing angle of the inspected item; the imaging parameters of each configuration respectively specify at least one camera viewing angle of the inspected item; and the estimating includes comparing camera viewing angles of the configurations to camera viewing angles of the imaging requirements.

According to some embodiments of the present disclosure, the estimating includes: accessing at least one image from visual inspection images generated using the one or more imaging parameter sets; automatically analyzing the at least one image according to a visual inspection requirement; evaluating validity of a result of the automatic analyzing; and producing an estimate of the fulfilment of the imaging requirement depending on the validity of the result of the automatic analyzing.

According to some embodiments of the present disclosure, an invalid result corresponds to an estimate of non-fulfilment of the visual inspection requirement's respective image input requirement set.

According to an aspect of some embodiments of the present disclosure, there is provided a system including an instruction executing unit and a memory which instructs the instruction executing unit to: access: one or more imaging requirements derived from visual inspection requirements for the inspected item, and imaging parameters specifying configurations of respective pre-configured visual inspection resources used to generate visual inspection images of the inspected item; determine correspondences between the imaging requirements and the imaging parameters, each correspondence being established by determining that: a visual inspection image produced according to the imaging parameters shows an inspection target which is a portion of the inspected item, and the inspection target is shown as specified by at least one of the imaging requirements; estimate, using the correspondences, fulfilment of the imaging requirements by visual inspection images generated using the imaging parameters; and generate a visual inspection plan fulfilling the visual inspection requirements, the visual inspection plan including the use of visual inspection images generated using the pre-configured visual inspection resources according to their respective pre-configurations.

According to some embodiments of the present disclosure, the correspondences determined are that: imaging parameters for a visual inspection image specify a camera pose relative to the inspected item; and the camera pose matches a camera pose defined by at least one of the imaging requirements.

According to some embodiments of the present disclosure, the correspondences are determined by analysis of visual inspection images generated according to the specifying imaging parameters.

According to some embodiments of the present disclosure, the analysis maps features of the visual inspection images to corresponding features of a 3-D model of the inspected item.

According to some embodiments of the present disclosure, each of the visual inspection requirements specifies: at least one component to be inspected and a visual inspection procedure testing the at least one component; and the imaging requirements specify images of the at least one component used in the visual inspection procedure.

According to some embodiments of the present disclosure, the one or more imaging requirements each respectively specify at least one camera viewing angle of the inspected item; the imaging parameters of each configuration respectively specify at least one camera viewing angle of the inspected item; and the instruction executing unit estimates by comparison of camera viewing angles of the configurations to camera viewing angles of the imaging requirements.

According to some embodiments of the present disclosure, the visual inspection plan specifies collection by a robotic imaging system of at least one additional visual inspection image, selected to complete fulfilment of at least one of the image input requirement sets.

According to some embodiments of the present disclosure, to estimate fulfilment of the imaging requirements, the instruction executing unit is instructed to: access at least one image from visual inspection images generated using the one or more imaging parameter sets; analyze the at least one image according to a visual inspection requirement; evaluate validity of a result of the analysis; and produce an estimate of the fulfilment of the imaging requirement depending on the validity of the result of the analysis.

According to some embodiments of the present disclosure, an invalid result corresponds to an estimate of non-fulfilment of the visual inspection requirement's respective image input requirement set.

According to an aspect of some embodiments of the present disclosure, there is provided a system including an instruction executing unit and a memory which instructs the instruction executing unit to: access: one or more imaging requirements derived from visual inspection requirements for the inspected item, and images of the inspected item obtained by visual inspection resources; determine correspondences between the imaging requirements and the images, each correspondence being established by: an image shows an inspection target which is a portion of the inspected item, and the inspection target is shown in the image as specified by at least one of the imaging requirements; select images potentially useful for fulfilling at least one of the visual inspection requirements, using the correspondences; use the selected images to calculate results of automated visual inspection procedures configured to fulfill the visual inspection requirements; estimate utility of the selected images in fulfilling the visual inspection requirements, using the calculated results; and generate, guided by the estimated utility of the selected images, a visual inspection plan fulfilling the visual inspection requirements, the visual inspection plan including the use of visual inspection images generated according to imaging parameters used to generate at least one of the selected images, and estimated to be useful in fulfilling the visual inspection requirements.

According to some embodiments of the present disclosure, the correspondences determined are that: imaging parameters for a visual inspection image specify a camera pose relative to the inspected item; and the camera pose matches a camera pose defined by at least one of the imaging requirements.

According to some embodiments of the present disclosure, the correspondences are determined by analysis of visual inspection images generated according to the specifying imaging parameters.

According to some embodiments of the present disclosure, the analysis maps features of the visual inspection images to corresponding features of a 3-D model of the inspected item.

According to some embodiments of the present disclosure, each of the visual inspection requirements specifies: at least one component to be inspected and a visual inspection procedure testing the at least one component; and the imaging requirements specify images of the at least one component used in the visual inspection procedure.

According to some embodiments of the present disclosure, the one or more imaging requirements each respectively specify at least one camera viewing angle of the inspected item; the imaging parameters of each configuration respectively specify at least one camera viewing angle of the inspected item; and the instruction processing unit estimates by comparison of camera viewing angles of the configurations to camera viewing angles of the imaging requirements.

According to some embodiments of the present disclosure, the instruction executing unit generates the visual inspection plan using a categorization of the visual inspection requirements, the categorization being made by the instruction executing unit according to the estimated utility of the selected images in fulfilling the visual inspection requirements.

According to some embodiments of the present disclosure, the categorization identifies at least one of the visual inspection requirements as having no corresponding image of the selected images useful for fulfilling it.

According to some embodiments of the present disclosure, the categorization identifies at least one of the visual inspection requirements as being fulfilled by the automated visual inspection procedures using one or more images of the selected images.

According to some embodiments of the present disclosure, the categorization identifies at least one of the visual inspection requirements as being partially fulfilled by the automated visual inspection procedures using one or more images of the selected images.

According to an aspect of some embodiments of the present disclosure, there is provided a system including an instruction executing unit and a memory which instructs the instruction executing unit to: access: one or more imaging requirements derived from visual inspection requirements for the inspected item, and images of the inspected item obtained by visual inspection resources; determine correspondences between the imaging requirements and the images, each correspondence being established by determining that: a visual inspection image produced according to the imaging parameters shows an inspection target which is a portion of the inspected item, and the inspection target is shown as specified by at least one of the imaging requirements; estimate, using the correspondences, fulfilment of the imaging requirements by visual inspection images generated using the imaging parameters; and generate a visual inspection plan fulfilling the visual inspection requirements, wherein the visual inspection plan uses different visual inspection resources positioned to image components of the inspected item at different stages of assembly.

According to some embodiments of the present disclosure, the correspondences determined are that: imaging parameters for a visual inspection image specify a camera pose relative to the inspected item; and the camera pose matches a camera pose defined by at least one of the imaging requirements.

According to some embodiments of the present disclosure, the correspondences are determined by analysis of visual inspection images generated according to the specifying imaging parameters.

According to some embodiments of the present disclosure, the analysis maps features of the visual inspection images to corresponding features of a 3-D model of the inspected item.

According to some embodiments of the present disclosure, each of the visual inspection requirements specifies: at least one component to be inspected and a visual inspection procedure testing the at least one component; and the imaging requirements specify images of the at least one component used in the visual inspection procedure.

According to some embodiments of the present disclosure, the one or more imaging requirements each respectively specify at least one camera viewing angle of the inspected item; the imaging parameters of each configuration respectively specify at least one camera viewing angle of the inspected item; and the instruction processing unit estimates by comparison of camera viewing angles of the configurations to camera viewing angles of the imaging requirements.

According to an aspect of some embodiments of the present disclosure, there is provided a method of integrating outputs of inspection resources into an inspection plan for an inspected item, the method including: accessing, by a computer: a data structure indicative of identifying characteristics of elements in the inspected item; one or more inspection requirements for the elements, an inspection work product provided as an output of an inspection resource and separately from the data structure; determining correspondences between the requirements and the inspection work product; estimating, using the correspondences, fulfilment of the inspection requirements; generating an inspection plan fulfilling the inspection requirements, the plan being adapted to avoid redundant testing of inspection requirements estimated to have been fulfilled by production of the inspection work product.

According to some embodiments of the present disclosure, the data structure indicative of identifying characteristics of the elements in the inspection item is indicative of their spatial positions.

According to some embodiments of the present disclosure, correspondences between the requirements and the inspection work product are established by matching of spatial coordinates encoded within the inspection work product to a corresponding element according to its position in the inspected item.

According to some embodiments of the present disclosure, the data structure providing spatial positions of elements in the inspected item includes an image of the elements.

According to some embodiments of the present disclosure, the image of the elements was produced by a same inspection resource that produced the inspection work product.

According to some embodiments of the present disclosure, the data structure providing positions of elements in the inspected item includes design documentation of the inspected item.

According to some embodiments of the present disclosure, the data structure indicative of identifying characteristics of the elements in the inspection item is a component identifier specified in design documentation of the inspected item.

According to some embodiments of the present disclosure, the data structure indicative of identifying characteristics of the elements in the inspection item is a part number specified in design documentation of the inspected item.

According to an aspect of some embodiments of the present disclosure, there is provided a method of integrating outputs of inspection resources into an inspection plan for an inspected item, the method including: accessing, by a computer: one or more inspection requirements for the inspected item, a token representing inspection work performed by an inspection resource, and a data structure linking the token to one or more inspection requirements; determining correspondences between the requirements and requirement tests represented by the inspection work product, using the token and the linking data structure; estimating, using the correspondences, fulfilment of the inspection requirements; and generating an inspection plan fulfilling the inspection requirements, the plan being adapted to avoid redundant testing of inspection requirements estimated to have been fulfilled by production of the inspection work product.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, will control. In addition, the materials, methods, and examples are illustrative only and are not intended to be necessarily limiting.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”).

Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable memory to receive instructions and/or data therefrom, process them, and/or store processing results in the same or another computer readable storage memory. The processing performed (optionally on the data) is specified by the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example, and for purposes of illustrative discussion of embodiments of the present disclosure. In this regard, the description taken with the drawings makes apparent to those skilled in the art how embodiments of the present disclosure may be practiced.

In the drawings:

FIG. 1 is a schematic diagram of a method of integrating outputs of pre-configured visual inspection resources into a visual inspection plan for a manufactured item, according to some embodiments of the present disclosure;

FIG. 2A is a schematic diagram of data element interactions optionally used in imaging parameter evaluation, according to some embodiments of the present disclosure;

FIG. 2B is a schematic diagram of data element interactions used in imaging requirement evaluation, according to some embodiments of the present disclosure;

FIG. 2C is a schematic diagram of inputs and outputs to a method of evaluating images for their usefulness in fulfilling imaging requirements, according to some embodiments of the present disclosure;

FIG. 2D schematically illustrates operations in the method of FIG. 2C, according to some embodiments of the present disclosure;

FIG. 2E is a schematic diagram of inputs and outputs to a method of evaluating images for their usefulness in fulfilling imaging requirements, according to some embodiments of the present disclosure;

FIG. 2F schematically illustrates operations in the method of FIG. 2E, according to some embodiments of the present disclosure;

FIG. 3A schematically illustrates a multiple-camera inspection line, comprising a plurality of cameras which image an item of manufacture at different stages of its assembly, according to some embodiments of the present disclosure;

FIG. 3B schematically illustrates an inspection station comprising a camera on a multi-axis robotic mount, according to some embodiments of the present disclosure;

FIG. 4 schematically outlines examples of use cases within which the method of FIG. 1 may be performed, according to some embodiments of the present disclosure; and

FIG. 5 schematically illustrates a system for integrating image outputs of disparate visual inspection resources into a visual inspection plan for a manufactured item, according to some embodiments of the present disclosure.

### DESCRIPTION OF SPECIFIC EMBODIMENTS OF THE INVENTION

The present invention, in some embodiments thereof, relates to the field of quality inspection and more particularly, but not exclusively, to automated visual quality inspection.

### Overview

An aspect of some embodiments of the present disclosure relates to the automatic integration of disparate inspection resources into a unifying inspection plan for quality inspection of an inspected item. The inspected may be, for example: an item under manufacture; an item receiving inspection for purposes such as documentation, maintenance, troubleshooting, and/or acceptance testing; and/or grading, for example as may be performed for an agricultural product. The inspection resources comprise software controlled sensing hardware. For example, imaging inspection resources in particular, comprise, e.g., cameras, optics, mounts (stationary or motorized), controlling hardware, image capturing and storage equipment, associated processing hardware, and control and/or analysis software. Non-visual inspection resources may comprise, for example, metrology devices in place of cameras and optics, or another type of sensing device.

Herein, moreover, the term “inspection resources” (including imaging inspection resources more particularly) includes equipment producing outputs available for use within an inspection environment (e.g., available for use by some embodiments of the present disclosure), whether or not the equipment was originally installed and/or configured for inspection uses as such. For example, in some embodiments, images produced by cameras placed along an assembly line for purposes such as documentation of throughput, monitoring equipment status, reading barcodes, securing monitoring, or the like are optionally used as input sources in some embodiments of the present disclosure.

### Integrated Automation of Inspection Planning

Inspection, including visual inspection in particular, is used as part of quality control processes for many different purposes, including but not limited to manufacturing, maintenance, acceptance testing, and/or grading. Automation of inspection potentially enhances final quality, increases efficiency, reduces costs, and/or reduces failure modes (e.g., inspector fatigue) associated with inspection as implemented manually.

Three distinguishable domains for inspection automation are (1) the determination of inspection requirements, (2) planning of inspection actions and resource allocations and setup that will satisfy these requirements, and (3) actually carrying out inspection and processing the results.

In some embodiments of the present disclosure, the inspection environment is heterogeneous in the level of automation of any one or more of these three domains. Often, there is a mix of manual and automatic activity. Automation may also be heterogeneous, with different automated systems in use, each potentially operating in accordance with disparate standards of operation. It is a goal of some embodiments of the present disclosure to provide systems and methods of integrating disparate inspection resources, existing and/or new, within a more unified and potentially more efficient inspection framework.

In some embodiments of the present disclosure, integration is achieved by using images and/or the imaging parameters used to generate them as type of “interchange format” that allows the activities of disparate inspection systems to be analyzed within a common framework. In some embodiments, non-image data is used to provide the interchange format.

More broadly, in some embodiments, integration comprises matching inspection requirements (e.g., as represented by a “smart” automated inspection planning system) to inspection results produced by other inspection systems. The results used may be inspection images themselves, inspection results the other inspection systems produce by analyzing those images, and optionally products of non-visual inspection procedures, such as metrology results. In some embodiments, information about manually performed inspection procedures and/or results are also accepted into the inspection plan and/or its implementation.

Herein, an automated inspection planning system is a system which is configured to generate a plan for inspection of an inspected item, by automatically transforming inspection requirements into inspection actions. An inspection planning system may go through several prior stages of processing to arrive at the inspection requirements. For example, the inspection planning system may parse design documentation into components and assemblies, and recognize what inspection requirements apply to those component and assemblies according to their types and/or other properties. Inspection requirements may be modified by general definitions and directives—for example, adjusting surface finish quality requirements according to standards of the factory and/or customer. Inspection actions may be produced at a level of detail appropriate to the persons and/or machines which will carry out the inspection itself; e.g., as written instructions (for use by a human), as low-level parameter values (e.g., for an inspection resource that requires explicit settings of positions and target value ranges in order to function), or as high-level specifications (e.g., for an inspection resource which the inspection planning system can “trust” to fulfill the specification by further elaborating it into its own more specific inspection actions).

An inspection planning system produce plans statically (e.g., for a certain design of an inspected item) and/or dynamically (e.g., allowing a plan to be regenerated to account for changes in factory conditions, particulars of an inspected item, or another reason). Any particular inspection plan may comprise a linear set of inspection actions, or allow branching for contingencies, e.g., based on planned variants of the inspected item, planned intermittent testing, and/or results of earlier inspection tests.

Specification of inspection actions uses information that the inspection planning system has about the inspection resources available to it. Herein, the term “inspection resources” refers specifically to equipment used to perform inspections and report inspection results, including cameras, imaging processing hardware and the algorithms the implement, metrology stations, and the like. The scope of the term “inspection resources” excludes staff allocated to operating the inspection resources.

However, the information available to the inspection planning system may be incomplete, for any of a variety of reasons. For example, within any given existing inspection framework (e.g., a factory floor and its equipment, capabilities, and established procedures) inspection resources may have been accumulated at different times from a variety of vendors, and operate according to technologies (and in particular, reporting and/or communication protocols) which are vendor- or era-specific. Inspection resources may be customized in their reporting and/or communication protocols. Inspection resources may be self-contained, e.g., reporting results through the use of indicators and/or printed material. This leads to a range of potential problems in the integration of an automated inspection planning system with those existing resources.

For example, it is, on one hand, potentially expertise- and work-intensive to configure and reconfigure automatic communications between systems for each new assembly floor situation. On the other hand, to the extent that human labor is used to bridge the gaps between different inspection machines (in particular as part of day-to-day inspection activities), there are potentially more opportunities for human error, bottlenecks, and/or other limitations on inspection automation efficiency gains.

In some embodiments of the present disclosure, inspection planning systems are configured to transform their internal representation of inspection requirements into forms which can be matched to (placed in correspondence with) types of inspection data which are commonly available, and effectively “generic”, at least in certain features which can be anticipated by capacities previously built in to the inspection planning system. Then those matches can be used to determine that the inspection requirement is being fulfilled outside the responsibilities of the inspection planning system.

Working from the other direction, additionally or alternatively: in some embodiments, inspection data are transformed or transduced (“tokenized”) by a straightforward process into a form which can be used to indicate (again, for purposes of finding correspondences with inspection requirements) at least certain key results of inspection processes; optionally without use of a specially programmed data interchange format. Tokenization, in some embodiments, is a method of converting a work product of an external inspection system into a form sufficiently general that it can be absorbed by the smart planning system according to one or more of the work product types it is able to process, and then placed into correspondence with inspection requirements.

Through use of correspondences established by using one or both of these types of transformations, the smart inspection planning system is able to build for itself an at least partial representation of the inspection environment outside of its own control. This is used, in some embodiments, to help increase inspection efficiency, e.g., by making the inspection planning system aware of which of the inspection requirements that it has identified are already being handled elsewhere. In some embodiments, moreover, byproducts of inspections already being performed (in particular, inspection images) are optionally re-used to perform additional processing, potentially reducing redundancy in raw data acquisition.

The types of inspection data useful for this approach may be generated, for example, as images, in forms which can be interpreted through images, in forms which can be interpreted geometrically in another fashion, for example through use of design documentation, and/or in forms which are readily treated as “tokens” of inspection results, without the need for developing a syntax-driven channel for digital electronic data exchange.

### Matching Images to Visual Inspection Requirements

Automated visual inspection equipment typically includes image capturing capability (one or more cameras along with supporting equipment for data capture and storage). Herein, the term visual inspection includes inspection based on any image-type data characterizing an inspection target, based on, for example, visible light, infra-red light (e.g., thermal imaging), X-ray imaging, ultrasound imaging, or another type of energy. The imaging sensor may be of any type appropriate to the modality, and the image produced may be represented in any appropriate computer-readable format; e.g., as 2-D and/or 3-D data; raster and/or vector data; and/or single-channel (e.g., grayscale) and/or multi-channel (e.g., color) wavelength and/or other property representation.

In some embodiments of the present disclosure, visual inspection requirements (of specific components and/or arrangements of components) are converted to be expressed more particularly in terms of imaging requirements (requirements for images needed to test the visual inspection requirements). Imaging requirements are in turn mapped to images and/or the imaging parameters that generate them.

A potential advantage of this conversion approach is that it provides a pathway to bring visual inspection requirements—which may be originally specified at a level fairly abstracted from the low-level inspection operations that eventually fulfill them—to a level where “the image is the interface” between systems. This allows images and optionally other inspection outputs (inspection work products) of visual inspection equipment to be applied to use in testing visual inspection requirements known by a planning system. The visual inspection requirements might, for example, not have been in view when the visual inspection equipment was originally configured; or they may have been known, but not formally specified in a way which allows direct communication of the pairing of visual inspection requirement and visual inspection work product to an inspection planning system.

### Imaging Configurations—Parameter-Based, Feature-Based

In some embodiments, conversion to imaging requirements translates certain parts of a visual inspection requirement into camera- and/or image-centric terms suitable for use in evaluating whether and for what purpose(s) a certain inspection work product is useful in the context of an overall inspection plan.

For example, a visual inspection requirement (also referred to herein simply as an “inspection requirement”) may specify that a certain component be checked for one or more quality-related properties; e.g., its presence, damage, alignment, tightness, or another visible property. Imaging requirements associated to the visual inspection requirement more particularly may specify imaging configurations useful for generating images which an automated inspection system needs in order to perform visual inspection tests (e.g., image processing) that satisfy the visual inspection requirement—e.g., to identify that the component is indeed present, undamaged, aligned, and/or secured. The imaging configurations may include, for example, camera pose specified relative to an inspected item, and/or illumination/exposure conditions of images taken.

If the imaging configuration associated with a certain image produced by visual inspection equipment is well-characterized (e.g., numerically specified in terms of angles and distances), the matching of imaging requirement to image may be performed to a large degree on the basis of parameter analysis—for example, parameters of a camera pose allowed by the imaging requirement are matched by parameters of the actual camera pose. The camera pose is optionally known from setup data, and/or from analysis of features in the image which provides information about how the camera was posed when the image was taken.

In some embodiments, the imaging requirement is at least partially based on image features themselves. For example, an image that shows a screw head may fulfill a functional imaging requirement that the screw head be shown round (e.g., rather than another shape as might be seen from an oblique angle). An important general image feature requirement is image focus, which is potentially more readily known from analysis of an actual image than from, e.g., numerical specifications of camera pose parameters.

An imaging requirement may mix imaging parameter-based and image feature-based characteristics. For example, the general characteristics of a camera pose may be determined from parameters known independently of any particular image. However, the actual usefulness of images taken from a certain camera configured according to that camera pose may be dependent on the associated overall imaging configuration; for example, aspects of focus or lighting only available upon analysis of the images themselves. The feature-based characteristic may comprise any suitable mix of analytical specification (size or focus metrics, for example) and functional specification (e.g., the image yields a valid result when processed by a certain visual inspection algorithm). Determination of camera pose itself (and/or other imaging configuration characteristics) may mix use of an approximate parameter-based specification with more precise feature-based validation using the shapes or other aspects of features shown in the images.

Correspondences with Imaging Requirements

Herein, an imaging requirement is said to be in correspondence with a certain image and/or to parameters specifying acquisition of that image if both of the following conditions are met:
The imaging requirement traces back to a certain inspection target (e.g., a component of the inspected item, or portion thereof) through one of the visual inspection requirements.
The visual inspection image—as it actually is, or as it is predicted to be based on the image acquisition parameters; and optionally including associated information generated by prior inspection operations—contains information that can be used to evaluate the inspection target as specified by the imaging requirement.

Moreover, in some embodiments, other types of inspection work products (e.g. image analysis results) are in correspondence with an imaging requirement via some intermediate correspondence through a visual inspection image (e.g., a visual inspection image used to generate the inspection work product).

For example, an image-producing inspection resource may be able to evaluate, from the images it obtains, the presence or absence of components on a circuit board; and may be capable (e.g., as a pre-existing documentation feature) of indicating inspection results on a copy of the image, for example as an overlay, indicating what region was inspected and/or what the result was. For example, regions that fail inspection may be particularly marked out.

In some embodiments, an inspection planning system, receiving the overlaid image and some specified and/or selected rules for interpreting it (e.g., rules equivalent to “boxes of a certain formatting indicate the location of an inspection failure” and/or “all component positions in this image have been inspected for component presence”), may be able to discern information about the originating system's outputs, even in the absence of a formal information exchange protocol with the originating system. This may extend, for example, to identifying the inspected components from their appearances and/or layout in the image; and/or to recognizing and/or interpreting image markup produced by the originating system (e.g., the overlay) based on its position, geometry, and/or coloration.

It should be noted that some work product information can be inferred without any use of auxiliary marks on an image. For example, in some embodiments, an inspection planning system is configured to recognize components in an image, and infer from this that the originating system “did its job” with respect to one or more visual inspection requirements (that is, it fulfilled them) such as the presence, positioning, and/or undamaged quality of components shown. Optionally, one or more classes of inspection requirements performed by the originating system are indicated to the inspection planning system, for example by manual entry and/or selection.

In some embodiments, a (non-image) indication of pass or fail (as a whole or in part) is passed to the inspection planning system. Optionally, the simple fact that the assembly bearing the imaged components has not been rejected at an earlier stage is treated as evidence that it has passed the checks of the originating system.

These image-based methods of linking visual inspection requirements to inspection systems outside of direct control by and/or formal protocol communication with an inspection planning system do not exclude establishing correspondences between visual inspection requirements and inspection work products using other available information, of which examples are given below.

Imaging requirement correspondences can be, for example: parameter-based, feature-based (including functionally specified features), or any combination thereof. In some embodiments, correspondence alone is treated as sufficiently supporting an estimation that the visual inspection image also fulfills the imaging requirement. Optionally, fulfilment and correspondence are treated separately. For example, it is not excluded that imaging requirements: may be divided, yet jointly satisfied (e.g., one image should satisfy two imaging requirements, each in a different characteristic); may partially overlap (e.g., one image should satisfy two imaging requirements, each in the same characteristic, but for a different range of characteristic values); and/or may satisfied by use of a plurality of images. Accordingly, as a further example, a plurality of correspondences may be jointly determined in order to support an estimation of the fulfilment of an imaging requirement or a set of imaging requirements.

### Target Type Identifications

Geometrical parameters (e.g., numerically specified camera positions, CAD models of the item being inspected) may help establish some features of requirement-to-image correspondences. However, these parameters may be insufficient or unavailable. For example, the geometrical information available may not be precise enough to specify from what camera locations within an assembly and/or inspection area a certain functional, feature-based imaging requirement can be fulfilled.

In some embodiments of the present disclosure, correspondence determinations and/or fulfilment estimations are performed using identifications of types of inspection targets belonging to the inspected item. Such types optionally include, for example, screws, labels, connectors, finished surfaces, and/or materials.

In some embodiments, the inspection target is type-identified without particular reference to inspection issues, e.g., as part of a design specification. The type identification is optionally useful as way of identifying the useful regions of requirement-corresponding images. For example, an image shows a surface area, the surface area is known from manufacturing documentation (e.g., a CAD or other model of the inspected item which comprises the inspection target) to include an identified screw. Accordingly, an appropriate region of the image receives the identification of screw based on this separate “type” knowledge.

Conversely, in some embodiments, the inspection target is type-identified from a potential requirement-corresponding image. For example, the image shows a screw, and an image region is assigned the type screw, based on identification made by inspecting of the image. The type identification itself may be used to identify a visual inspection requirement and the imaging requirements that go with it. Optionally, the image and/or the identified screw region are separately matched to a model of the inspected item.

Type identification of targets optionally merges the two general directions from which type identifications can be made: model-to-type (to image), and image-to-type (to model). For example, a more general type (e.g., connector) can be identified and assigned to an image region (image-to-type), while narrowing of the identification to a more specific type (e.g., RC-45 jack) is determined in reverse (mode-to-type), after using the image region's more general type assignment as a connector to help assign the image region as corresponding to a geometrically particular portion of a detailed model of the inspected item.

Type identifications driven at least in part by direct inspection of images themselves have the potential advantage of reducing and/or circumventing the need for precise geometrical knowledge of the imaging parameters used in an inspection setting. It is enough, in some embodiments, to know that an image (1) shows a certain inspection target, and (2) is “good enough” to use, without having explicit information about, e.g., how camera and inspection target were positioned with respect to each other and/or lighting conditions.

### Inspection Specified by Target Type

Furthermore, in some embodiments of the present disclosure, visual inspection requirements are themselves generated through the use of type identifications, creating a potential synergy with types identified in visual inspection images.

In some embodiments, associated with each type there is an at least partial specification of how a target assigned such a type may be visually inspected that is, a specification of a visual inspection test. An inspection test is associated to a particular target through a visual inspection requirement.

In some embodiments, the inspection test specifies imaging configuration parameters (e.g., camera pose, lighting, imaging angle, focus quality, image resolution, and/or other imaging configuration properties). These may be interpreted as imaging requirements, in the sense described above. Accordingly, in some embodiments of the present disclosure, a chain of entailments such as the following one is used:
the type of a target determines relevant visual inspection requirements,
the visual inspection requirements actually selected imply the use of certain inspection tests, and
the inspection tests in turn yield the imaging requirements which the visual inspection requirements entail.

It should be noted that although type identification is a useful gateway to identifying imaging requirements, it is not a necessary one. For example, in some embodiments, manual selection is initiated at any of the stages of the above “chain of entailments” to arrive at or even directly select imaging requirements. Optionally, manual and automatic identifications are mixed. Automatic identifications may optionally be confirmed or excluded by manual intervention, e.g., through a computerized user interface.

### Correspondence Determinations

Correspondence determinations optionally are parameter-based, in that they comprise matching image acquisition parameters of visual inspection equipment (optionally associated with actual images) to imaging requirement-specified image acquisition parameters. It should be noted that both the inspection test and the image are optionally specified by parameters with the same or similar meanings, facilitating their comparison. It should also be noted that parameter matching can optionally be performed even without the images themselves—it is optionally enough to know how the image is taken (e.g., parameters of the camera pose and other imaging configuration parameters).

Additionally or alternatively, in some embodiments, correspondence determination is feature-based. For example, an inspection test specifies a visual inspection routine for the target's identified type, as performed on an image portion imaging the target. If the inspection returns a result consistent with the target's actual state (successful inspection is performed), the image is functionally estimated to match a certain visual inspection requirement.

Again, parameter-based and feature-based correspondence determinations are optionally used together—for example, parameter matching may narrow candidate correspondence determinations, and feature-based matching may finalize and/or confirm these determinations. Additionally or alternatively, feature-based correspondences are identified, and imaging parameter correspondences evaluated selectively for the cases of feature-based correspondence.

Images, as already noted herein, can also serve as intermediaries for correspondence determination. The images may be annotated according to a formal data interchange protocol that the inspection planning system (and inspection systems that operate according to its plans) already understands; but images can also be used, in some embodiments, to work around the lack of a formal data interchange protocol.

In particular: an inspection system external to configuration and/or control by an inspection planning system may be configured to produce inspection results that reference assembly components according to their X-Y positions in one or more images used to perform the inspection—in addition to any other report information it produces.

The inspection planning system is, moreover, optionally unaware of how to interpret other reporting fields produced by the inspection system (e.g., specific part identifications). In this sense, there is a lack of a formal data interchange protocol which the inspection planning system shares in common with the source of the reporting system.

However, the inspection planning system, in some embodiments, is configured to identify and use bare coordinate information to identify corresponding inspected locations on the image. Then, from its own identifications of component types present at those places, make a correspondence match to inspection requirements the inspection planning system is aware of and is generating a plan to fulfill.

This is facilitated by the use of common field names like x, y, top, left, bottom, right, width, height to label to geometrical information; which may help with automatic parsing of geometrical information from inspection results. Additionally or alternatively, fields in inspection results are manually selected/confirmed for use.

In a sense, the constraints of spatial geometry, common to many different types of inspection systems as a matter of their operating conditions, are converted to a channel for data exchange about inspection results that potentially bypasses a need for creating case-by-case formal information exchange protocols between the inspection planning system and the other systems and tooling of the quality inspection environment. This potentially allows an increased level of agnosticism about the detailed operation of systems from different manufacturers, operating according to different standards, and/or with unanticipated capabilities.

### Non-Image Spatial Correspondences

In some embodiments, spatially indexed inspection output data, e.g., as may be produced by a metrology system, is absorbed directly without use of an image intermediate. Correspondences are instead determined by making reference to knowledge that the automated inspection planning software has about the inspected item's design. In some embodiments, the product design files (e.g., 3-D design files) replace the role of the image in assisting the planning system to interpret the inspection result files it receives. In some embodiments, spatial locations to which metrology results are indexed (e.g., as may be determined from assessment of tags included in inspection output files) are correlated with positions of components known from the design files.

In an example scenario, a device being inspected one or more circuit boards, circuit board regions, and/or stages of circuit board assembly relevant to inspection planning. Spatially indexed inspection results for these subassemblies are being produced in, e.g., an XML-related file format for at least some of these boards, regions and/or stages, by an inspection system operating according to a protocol unknown to the inspection planning system.

The inspection planning system is optionally not preconfigured with specifics of the formatting of the inspection results (e.g., unfamiliar with the meanings of component identifiers and/or result indications), but is nonetheless able to recognize a subset of fields comprising spatial coordinates; for example according to field names, tag names, structuring of coordinates in ordered pairs, or another convention common in the representation of spatial coordinates.

The inspection planning system, in some embodiments, matches patterns of inspection result coordinates to corresponding patterns of inspectable features which it determines by parsing of design documentation. In the example scenario, the inspection planning system may receive metrology results comprising coordinates at which metrology tests were performed for some subassembly (such as a circuit board) of an inspected item—but not be able to deduce from those results alone which components were actually tested, and/or, for example, in what orientation the subassembly was placed for testing. Optionally, even which subassembly was tested is initially unknown.

However, access to design documentation allows the inspection planning system to determine a component layout of the subassembly which was tested. Presumption that the metrology results were focused on inspecting those components, the inspection planning system, in some embodiments, establishes correspondences between coordinates in the inspection work product and the coordinates of components as detailed by the design documentation, e.g., by using an error minimization algorithm to find appropriate scaling, orientation, and translation to match the two coordinate systems. If even the identity of the particular subassembly is unknown, and/or its stage of assembly, this is deduced, in some embodiments, by attempting matches from a plurality of different subassemblies, optionally in varying stages of completion.

In some cases, an inspection system's results are associated through non-spatial data with elements specified in the CAD design. For example, the inspection results produced may be associated with internal identifiers used in the CAD documentation itself, and/or with extrinsic identifiers such as part names, and/or part catalogue numbers. The identifiers may be back-associated with the CAD documentation (e.g., via insertion to and/or reference from the CAD documentation itself), and/or provided in a separate form, such as a list (e.g., a list of the results of individual inspection actions, with the identifiers being provided as fields in some or all of the results.

In some embodiments, the inspection planning system establishes correspondence of the inspection system results to inspection requirements known to the inspection planning system based on data patterns in the results. For a suitable generic class of unfamiliar inspection system outputs, this can allow the inspection planning system to understand at least part of the data being generated the absence of being specifically “taught” to read these outputs in detail.

Identifying such a pattern, in some embodiments, comprises identifying fields of the unfamiliar inspection system's outputs which contain data matching what the inspection planning system finds in the CAD design files. For example, a field may be identified by its recurring position (e.g., column position) or label (e.g., XML element attribute or type) in the unfamiliar inspection system's output, and moreover that identified field may be repeatedly filled with data matching numbers and/or character strings used in the CAD design, e.g., part numbers, internal reference identifiers, and the like. If, for example, the CAD design specifies components identified as screw_1, screw_2, connector_1 and the like, then the occurrence of the same strings in the unfamiliar inspection system's output is optionally treated as indicative of an inspection result attached to those components. In another example, the unfamiliar inspection system's results may be specified in terms of a general part number, where each of a plurality of identical screws is identified by its part number, but not necessarily as an individual component. The inspection planning software may identify patterns in the number and/or grouping of such parts. For example, if there are as many screws mentioned by part number in the unfamiliar inspection system's output as are defined in the CAD design of some particular subcomponent or surface of the inspected item (or of the inspected item as a whole), then the inspection planning system optionally uses this as evidence that all those screws are being inspected by the unfamiliar inspection system.

Without knowing more about the actual results of the inspection (i.e., in the absence of a fully specified data exchange protocol known to both the originally inspecting equipment and the inspection planning system), this result of knowing that a component is inspected, may still be useful. For example, an “already inspected” designation may be assigned to components which are determined to have at least been tested during the production of the inspection (e.g., metrology) results. This allows the inspection planning system to produce an inspection plan which includes no further testing of requirements associated with those components individually or in aggregate; or at least no further testing of requirements of a type which a certain inspection modality (e.g., metrology) normally tests.

Optionally, the inspection planning system treats components which it finds have undergone inspection as having in fact passed inspection, in the case that a subassembly that failed the inspection can be assumed to be rejected in any case.

These “pass/fail” type uses of inspection results, in some embodiments, are optionally generalized to other uses via a tokenization scheme, for example tokenization as described in the next section.

### Non-Image Correspondences Through Tokenization

In some embodiments of the present disclosure, making correspondences between inspection work products and visual inspection requirements is assisted by activities of a device operator and/or assembly and/or inspection workers. There may also be generic side-effects of an inspection device such as the generation of a file with a certain name pattern, time-stamp, or other characteristics which allows determination that some kind of inspection has happened, without details of the inspection results necessarily being available and/or understood by the inspection planning system.

In a simple group of embodiments, manual input from a system operator instructs an inspection planning system to simply disregard a certain visual inspection requirement, because the system operator knows that the inspection requirement is being otherwise attended to.

In some embodiments, an inspection planning system is instructed to treat a token generated by an originating inspection system (and/or its operator(s)) as “evidence” of one or more inspection results. The inspection planning system, in some embodiments, is configured to recognize that such tokens are potentially present to be identified (optionally without being parsed or otherwise understood in any greater detail); and further what the identified token should be taken to signify for purposes of inspection planning.

The method of identifying a token may comprise imaging (e.g., of a sticker or tag), may comprise a reading method such as bar code scanning or RFID tag reading, and/or may comprise another sensing modality, such as detecting the presence of a magnet, weight, ultrasonic transducer, or other object which, upon being sensed (and optionally characterized further), serves as a token indicative of inspection results. The token may be represented in non-physical form; for example, the presence of a file on a file system having a name which corresponds to a serial number or other identifier of a component and/or assembly. The file may have been created by an inspection system which produces inspection results, the details of which are opaque (unknown, at least in part) to the inspection planning system.

In some embodiments, the inspection planning system is configured so that the bare fact of a token's presence conveys information about externally performed inspection results. For example, a sticker of a certain color is taken as confirmation that some predefined set of inspection targets (e.g., all of those visible from a certain view, all of those on a certain sub-assembly, and/or all of those of a certain type) has met or not-met a predefined set of inspection requirements. A file, in the role of a token, may only be placed in a certain file directory if it is indicative of an inspection success (or failure). The token optionally conveys that a certain assembly is to be treated as a sample which should be subjected to special inspection, e.g., for statistical purposes, and/or to measure tooling-based quality effects such as wear and/or calibration changes. The association between a token and its meaning for planning is optionally specified by an operator during set up (e.g., by choosing from a list of selections). Optionally, certain standard tokens and their meanings to the inspection planning system are predefined within a certain inspection environment, so that they can be used freely thereafter to “talk” to the inspection planning system (and/or systems that operated under control of a plan it generates) without additional configuration.

In some embodiments, the inspection planner incorporates token-meaning information into its overall planning as appropriate; e.g., it may plan the execution of different branches of the inspection plan, depending on the presence or absence of the token. A potential advantage of this method is that the interface through which information is provided to the inspection planner (and later, inspecting systems following the plan produced) is easily implemented on site without system reconfiguration, and optionally without computerized system expertise, by simply issuing work instructions to factory workers. As examples: “if the result (of the external inspection system) is a pass, put the red sticker on the circuit board”, “put a weight in the assembly's carrying bin to indicate inspection failure”. What specifically was tested may not be communicated at all (e.g., the inspection planning system is allowed to simply assume that inspection requirements have been handled), or it may be determined by the inspection planning system using another method, with the token being an indication of an overall result.

In some embodiments, the token is more explicitly informative, and comprises a an element bearing, e.g., an informative text, identifier, and/or bar code data. The inspection planning system is configured to detect the element (e.g., from images it itself takes, from a laser scanner, and/or from near-field communication device), and/or to parse it as appropriate. The token may directly carry information, or may specify a link (e.g., a universal resource locator) to the information. The token may simply comprise a serial number or other generic identifier, acting as a key which may be used to reference inspection results, e.g., in one or more tables of a database. The information present and/or referenced may be very simple (e.g., a binary result which the inspection planning system is configured to interpret), or arbitrarily complex (e.g., a table of inspection tests and their corresponding results).

It is understood that as complexity of the token-indicated information mounts, correspondence determination begins to taken on features of a formal information exchange protocol, optionally including to the point that the information exchange protocol can be configured to carry with it information about what actual inspection requirements are being addressed. In some embodiments of the present disclosure, such protocols (e.g., database table transforms), are also available for use by an inspection planning system; e.g., as preconfigured for use with certain common inspection equipment, or developed on an ad hoc basis by specialized technicians and/or information technology personnel.

Nevertheless, it is a particular feature of some embodiments of the present disclosure that an inspection planning system is configurable to accept token indicators in a manner which places the burden of relating the token to particular inspection requirements on the inspection planning system and its own adapted configuration, rather than on the system originating the inspection result, or on the contents of any data conveyed as part of the token indicators as such.

Embodiments having this particular feature may, for example, be characterized by one or more of the following in their implementation:
The token is an inherent byproduct of inspection processes not configured according to a plan produced by the inspecting planning system; and the inspection planning system (and/or inspection resources configured according to its plan) treat the token an implicit indication of the operation and/or results produced by an external inspection system. For example, if an assembly is present at a certain stage of manufacture, this “mere presence” may itself be taken as a token and implicit indication (within the context of the inspection plan) that certain inspection requirements are fulfilled, and do not need to be further tested according to the plan produced by the inspection planner. In other words, “it wasn't rejected yet”, so whatever it has been inspected for it can be presumed to have passed.
The token is an inherent output product of inspection processes not configured according to a plan produced by the inspecting planning system; but the output product as such does not convey to the inspection planning system what actual requirements the output product is intended to satisfy. Instead, in some embodiments, the inspection planning system infers satisfied requirements, the inference comprising associating generic features of the output product (e.g., geometrical data) to inspection requirements via the intermediate assignment of a target type (identified using the generic features); wherein the target type is in turn associated the inspection requirements. This may be done, for example, via images and/or design specification information.
The token comprises a physical object associated to the object being inspected (for example a tag attached to an assembly by a factory worker), and the inspection planning system (and/or inspection resources configured according to its plan) is configured to treat the token as indicative of the fulfilment state of certain inspection requirements. The fulfilment status of the certain inspection requirements is set by the operations of an originating inspection system which is not itself configured and/or controlled according to an automated inspection plan product by the inspection planning system. Furthermore, association of physical object is not inherent to the operation of the originating inspection system. In some embodiments, an inspection plan produced by the inspection planning system itself instructs the use of the physical object as a token; e.g., as a work directive issued to factory workers. The physical object may carry machine-readable information, or it may be indicative in another manner; e.g., by its presence and/or positioning.

### Semantic Inspection Terminology

Identified types are also referred to herein as “semantic identifications”. The type identification itself may be considered simply as a label. But within an overall inspection system, this label is associated with further information (called semantic information, herein, or equivalently, “semantics”) that give the label further significance. Herein, the term semantic information is used to indicate information that enters into a process (performed by a computer processing system, for example) as part or consequence of denoting something (e.g., denoting a component with a semantic identification).

For example, the label SCREW associated with a certain surface patch of an inspected item implies inspection-related semantic information, in some embodiments of the present disclosure. The semantic information may include geometric information: e.g., that the SCREW patch comprises a circular region (the screw head) and a slotted region (the socket of the screw head). The semantic information may include specification about what inspections should be performed: e.g., that a SCREW should be inspected for tightness, and/or for damage to the socket. Geometric semantic information might be relied on to perform this inspection. The semantic information may include specification of what further identifications of the SCREW patch are possible (e.g., head type and/or socket type is present). Although all of this semantic information is external to the semantic identification SCREW, the inspection system is configured to establish links between the two to enable the relationship between semantic identification and semantic information.

### Integration Scenarios

A variety of inspection scenarios are addressed by embodiments of the present disclosure. With respect to existing configurations of visual inspection equipment, the configuration may be, for example, validated, evaluated for potential redundancies, and/or evaluated for missing visual inspection test data. The existing configuration may be, for example, one which provides a set of general purpose visual inspection images, a configuration which has been partially developed, and/or a configuration being adapted to the manufacture of a new product. In some embodiments, a configuration (new or existing) is defined by a model, and the model evaluated for its ability to fulfill visual inspection requirements. Optionally, the model is modified based on the evaluation.

In some embodiments, visual inspection is divided among a plurality of stations, optionally each operating at different stages of assembly of an inspected item.

Before explaining at least one embodiment of the present disclosure in detail, it is to be understood that the present disclosure is not necessarily limited in its application to the details of construction and the arrangement of the components and/or methods set forth in the following description and/or illustrated in the drawings. Features described in the current disclosure, including features of the invention, are capable of other embodiments or of being practiced or carried out in various ways.

Evaluating Visual Inspection Resource Configurations with Respect to Visual Inspection Requirements

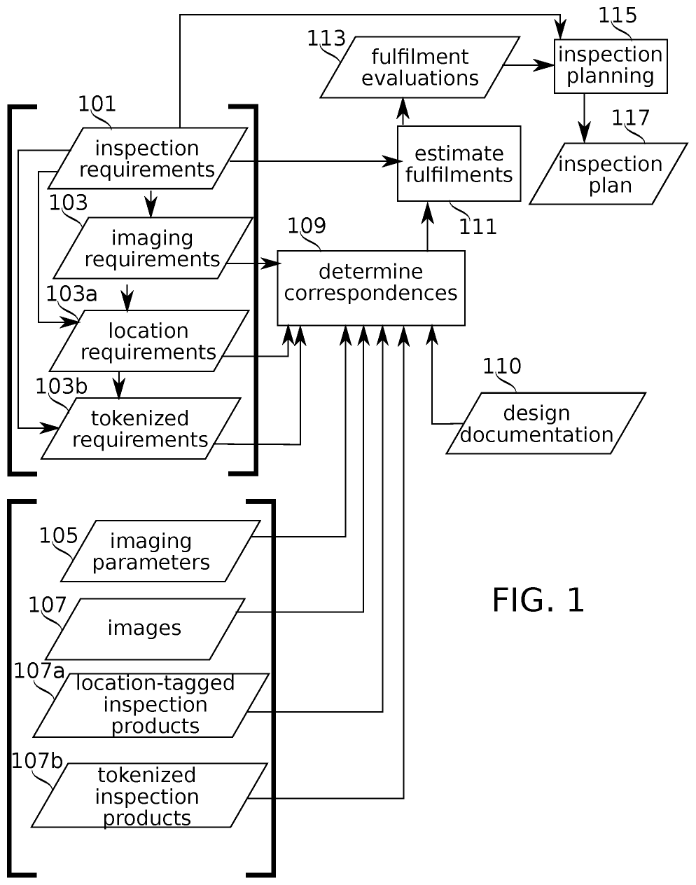

Reference is now made to FIG. 1, which is a schematic diagram of a method of integrating outputs of pre-configured visual inspection resources into a visual inspection plan for a manufactured item, according to some embodiments of the present disclosure. Method operation blocks of FIG. 1 include:
determining correspondences 109,
estimating fulfilments 111, and
inspection planning 115.

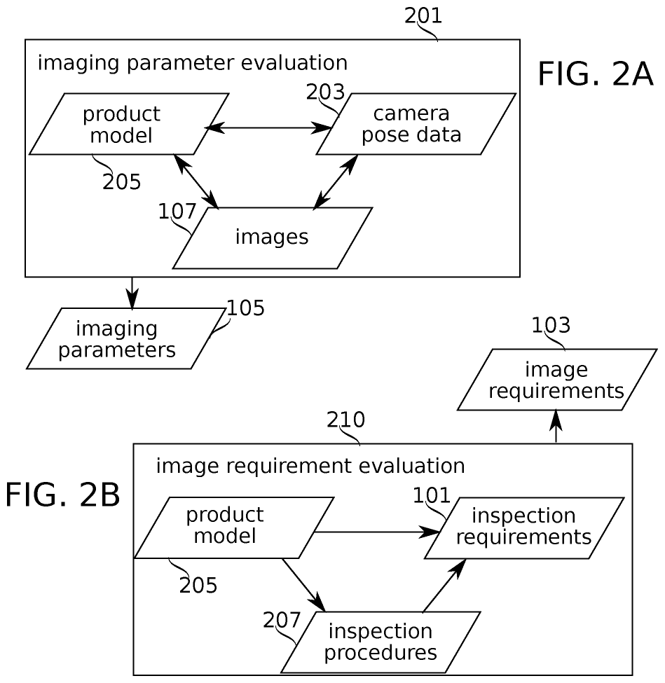

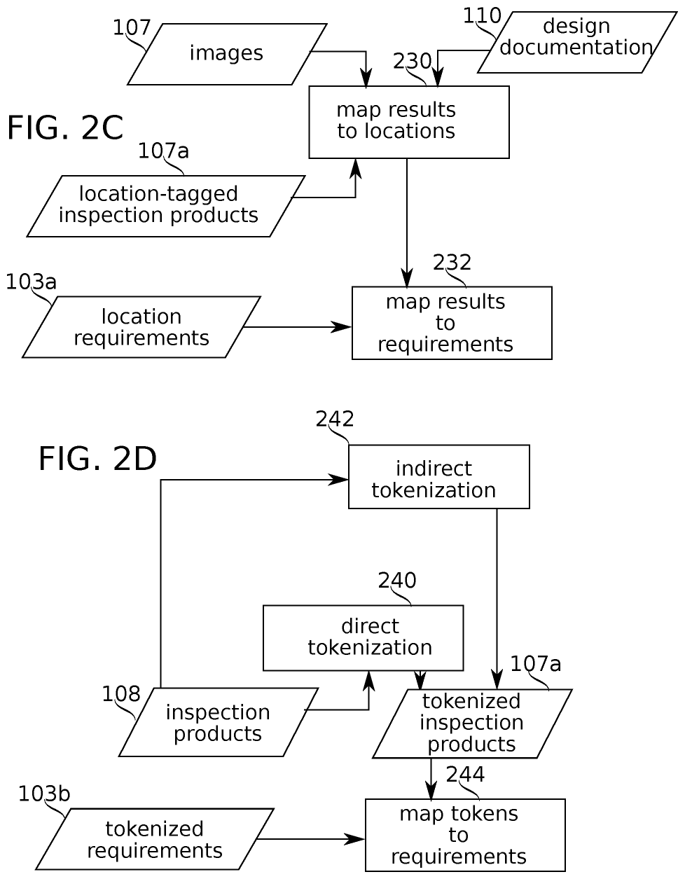

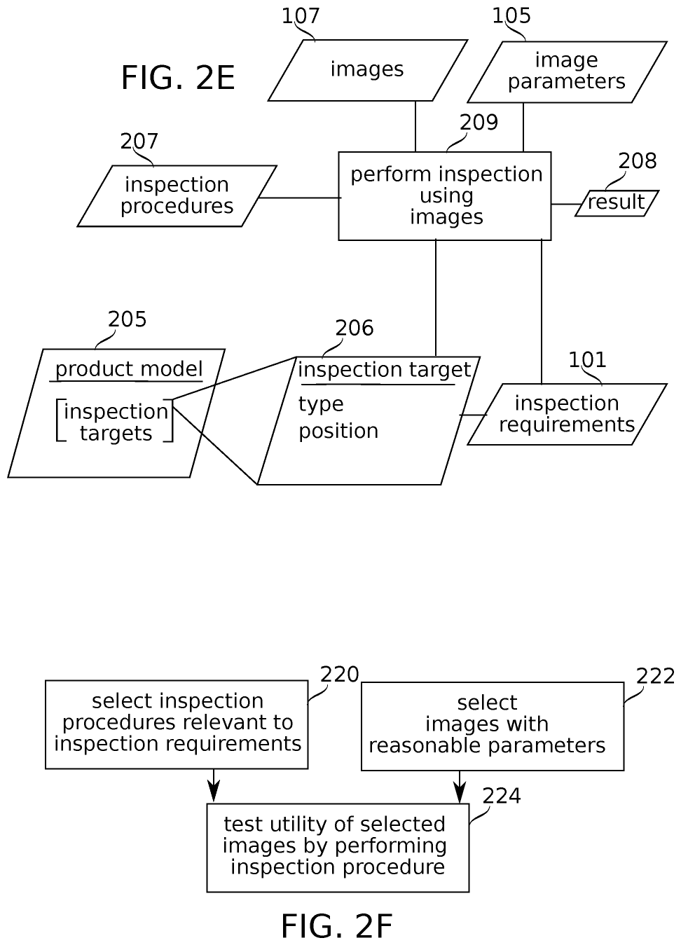

Other blocks of FIG. 1 are inputs and/or outputs of one or more of these blocks. Some of the inputs/output blocks are optionally produced as the product of further operations, for example as described in relation to FIGS. 2A-2B.

Correspondence determining 109, in some embodiments, comprises processing each of one or more imaging requirements 103, location requirements 103a, and/or tokenized requirements 103b derived from a respective inspection requirement 101 to determine correspondences (if any) to one or more of imaging parameters 105, images 107 (obtained by a camera configured according to certain of the imaging parameters 105), location-tagged inspection products 107a, and tokenized inspection products 107b.

In the case where an inspection requirement 101 is more particularly a visual inspection requirement, correspondence comprises two criteria, namely:
An imaging requirement 103 relates to a certain inspection target (e.g., a component of an inspected item, or portion thereof) through one of the visual inspection requirements 101 which apply to that inspection target.
The visual inspection image 107—as it actually is, or as it is predicted to be based on the image acquisition parameters 105—shows the inspection target as specified by the imaging requirement 103.

Processing methods for determining correspondence may be parameter-based (e.g., camera angle parameters should match imaging requirement angles), and/or or feature-based. Feature-based methods of correspondence determining which directly evaluate images for their utility in inspection procedures are described in relation to FIGS. 2E-2F herein.

It is also noted that either of imaging parameters 105 and images 107 is optional, in some embodiments, depending on the method of correspondence determination being performed. In particular, imaging parameters 105 might be provided as original input, and/or derived from analysis of images 107 and other information (e.g., a product model 117). Additionally or alternatively, inspection of images 107 is used to test and/or verify that their associated imaging parameters are actually in suitable correspondence with an imaging requirement 103.

Other embodiments are indicated with respect to location requirements 103a (to be corresponded with location-tagged inspection products 107a), and with respect to tokenized requirements 103b (to be corresponded with tokenized inspection products 107b). These are discussed more particularly in relation to FIGS. 2C and 2D, respectively. In some embodiments, design documentation 110 is used in the determination of correspondences; for example, as also discussed in relation to FIGS. 2C-2D.

Fulfilment estimating 111 produces fulfilment evaluations 113. Fulfilment evaluations 113 relate images 107 and/or imaging parameters 105 (and/or other correspondences of requirements and inspection products) back to inspection requirements 101 through their correspondences with inspection requirement-derived imaging requirements 103, location requirements 103a, and/or tokenized requirements 103b. Optionally, fulfilment evaluations 113 comprise a data structure which encodes these relationships (e.g., in XML, YAML, or another data structuring computer language). In some embodiments, fulfilment evaluations 113 comprise classifications of inspection requirements 101 according whether each, some, or none of the inspection requirement's derived-from imaging requirements 103 (for example) are in correspondence with some group of imaging parameters 105 and/or image 107. Optionally, redundantly fulfilled imaging requirements 103 (for example) are identified. Fulfilment evaluations 113 optionally encode graded fulfilment information. For example, an imaging requirement may be fulfilled marginally by an image which is good enough for use in detecting large flaws, but not small flaws. Although not shown as direct inputs to fulfilment estimating 111, the processing of fulfilment estimating 111 optionally makes direct use of any of imaging requirements 103, imaging parameters 105, and images 107 (and/or or other inspection products 107a, 107b; and/or requirements 103a, 103b).

Inspection planning 115 receives as input at least the inspection requirements 101 and the fulfilment evaluations 113. An inspection plan 117 is produced by the inspection planning. Use of the fulfilment evaluations 113 in producing inspection plan 117 is described, for example, in relation to FIG. 4, herein.

### Imaging Parameter Evaluation

Reference is now made to FIG. 2A, which is a schematic diagram of data element interactions optionally used in imaging parameter evaluation, according to some embodiments of the present disclosure.

In some embodiments, imaging parameters 105 are provided as input to the method of FIG. 1 from an independent source; for example, as values which explicitly specify characteristics such as the angle and/or distance of a camera from features it images, exposure settings, focus settings, lighting arrangements, and/or image resolution. The imaging parameters 105 are optionally provided in a format which can be directly compared to the imaging requirements. Optionally they are transformed as necessary as part of the operations of determining correspondences.

Optionally, imaging parameters 105 are derived from a mix of sources. FIG. 2A illustrates three such sources. Available camera pose data 203 may be directly used (for example, if it is specified numerically for each degree of freedom) and/or transformed as necessary (for example, if imaging parameters are generated from indirect information, such as the appearances of targets in inspection and/or calibration images) to provide imaging parameters 105. At least some of the camera pose data may, alternatively, be in a form which needs additional (e.g., manually provided) information to be used, for example, indications of target distance, or timing of target and/or camera movements. In some embodiments, the additional information comes from one or both of product model 205 and images 107. Product model 205 models the inspected item, for example as a 3-D model of the inspected item. Images 107 are images taken using the imaging parameters which are to be determined.

As an example of how mixed sources may be used: in some embodiments, camera pose data is available as relative camera poses, but lacking full information about how those camera poses define a view onto features an inspected item being imaged (e.g., where the inspected item actually is positioned). Optional joint analysis of camera pose data 203 together with images 107 (produced from particular camera poses defined in camera pose data 203) and/or product model 205 determines information to complete imaging parameters 105. “Completion” means that imaging parameters 105 are sufficiently defined for use in determining correspondences with imaging requirements 103. In some embodiments, joint processing works from images 107 and product model 205 without use of separately provided camera pose data 203.

In a broad example of joint processing: features shown in images 107 are used to register the images to the 3-D space of product model, based on their identity with features defined in product model 205. This will typically also result in constraints on where the camera could have been (that is, the camera's pose) in order to image the features as they have been identified. These constraints may be sufficient in themselves to provide imaging parameters 105, or they may be used as constraints on the interpretation of available camera pose data 203 to produce imaging parameters 105.

In a more particular example, the product model 205 explicitly identifies certain features according to their types (e.g., fasteners, ports, surfaces, controls, displays, and/or groupings thereof). Locations of features of the same types are identified in images, for example, based on machine vision techniques (e.g., use of a machine learning product trained on examples of the features), manual identification, or another method. From correspondences between such features, constraints may be laid upon the camera pose used to obtain the images 107 to produce images which are also consistent with the geometry encoded in product model 205. It should be understood that other methods of joint processing are optionally performed; for example, based on the identification of edges, textures, or other visually identifiable features.

It may be noted that the arrows of FIG. 2A each go in both directions. This reflects, for example, the following set of optional relationships implemented in some embodiments of the present disclosure:
Camera pose data 203 may be used to take images 107 which in turn are informative of camera pose relative to an imaged inspected item.
A product model 205 may be constructed at least in part based on the use of images of a sample of the inspected item. For example, inspection targets detected in images may be used to identify overlap across images to help reconstruct a 3-D model of the inspected item which is consistent with the various imaged views available. Additionally or alternatively, a product model 205 may be used to help detect and/or analyze features in images 107.
Once a product model 205 is registered to the frame of reference in which camera pose data 203 are defined, the product model 205 can be used to help define what features will be visible in images taken from some particular camera pose. Additionally or alternatively, camera pose data 203 may be used jointly with images 107 to help construct product model 205, by constraining the range of views onto a sample of the item of manufacture which the various images 107 can be considered to provide.

As mentioned in relation to FIG. 1, imaging parameters 105 are optional in some embodiments of the current disclosure. This may be, for example, because imaging requirements 103 are specified in terms of functional and/or feature-based requirements that do not explicitly specify imaging parameters as such. These types of requirements are further discussed in relation to FIGS. 2B and 2E.

### Imaging Requirement Evaluation

Reference is now made to FIG. 2B, which is a schematic diagram of data element interactions used in imaging requirement evaluation, according to some embodiments of the present disclosure.

Again, three data sources are shown as examples of inputs that may be processed (evaluated) into imaging requirements 210: product model 205, inspection requirements 101, and inspection procedures 207.

Product model 205 is as discussed and defined in relation to FIG. 2A.

As described hereinabove, each (visual) inspection requirement 101 specifies that a certain component (which might itself comprise a plurality of components, for example an assembly, group of otherwise related components, and/or the completed inspected item itself) be checked for one or more quality-related properties.

The inspection requirement may be specified with different levels of specificity. For example, an inspection requirement may be specified in detail at the level of a specific characteristic and/or measuring method (e.g., a mounted angle of a component should be seen to be within a certain target range as seen from a particular vantage). This is also referred to herein as a “closed” inspection requirement, defined in terms of primitives which directly specify what is to be measured (and optionally even how).

Alternatively, an inspection requirement may be specified at the level of a concern, the concern being open as to exactly what characteristic(s) and/or measurement method(s) should be used in testing. For example, a concern may be “verify that the screw head is undamaged”. A potential advantage of such open inspection requirements is that they can be readily attached to inspection targets as semantic information, based on semantic identifications of the target made separately. In particular, a product model 205 may label (or otherwise structure) its components in such a way as to provide ready semantic identifications. For example, whatever defined element the product model 205 labels as a SCREW, PORT, or SURFACE FINISH should be inspected (at its defined position) according to concerns defined in an inspection system for screws, ports, and surface finishes, respectively. If the concern is addressed, the inspection requirement is fulfilled. Different inspection systems could address the same open-specified inspection requirement with different particular inspection procedures, and optionally different models of component characteristics.

Both types of visual inspection requirement are reducible in part to the specification of one or more corresponding imaging requirements 103.

In some embodiments, the specification comprises the application of one or more partially specified inspection procedures 207 to a particular inspection target defined by a product model 205, to which an inspection requirement 101 is attached:

For example:
A screw (having a particular position and part characteristics specified in product model 205) is subject to the openly defined inspection requirement “the screw should be tightly fastened”.
One of the inspection procedures 207 defines, among other operations, how (generically) to obtain images of a screw so that this inspection requirement can be satisfied. For example, it may be specified by the inspection procedure that there should be at least one image obtained from a position along the shaft axis of the screw, and another taken from a known position at least 10° away from the shaft axis. Such images are optionally used, for example, to evaluate the parallax of the screw against its background.
The product model 205 provides specifics which finalize the partially specified inspection procedure 207; for example, the particular position of the screw, and the ranges of image processing results (e.g., parallax measurements) which show that the inspection requirement has passed or failed.

It should be noted that a sufficiently detailed (closed) inspection requirement 101 may itself define an inspection procedure 207, but the “procedure” part of the inspection requirement 101 can be considered as separate for purposes of description.

A distinction is described hereinabove between parameter-based and feature-based imaging requirements. In the example just given, the position of the screw is particularly relevant to a parameter-based imaging requirement. Given the screw position, the imaging requirement can be generated without considering what any particular image of the screw actually shows.

A feature-based imaging requirement, in contrast, specifies more particularly how an image of a feature should look (how it appears in a representative image). For example, there could be a requirement for an image that shows the screw-head perfectly round (e.g., as it would look from a position along the shaft axis), and another requirement for an image that shows the screw head with a defined distortion from perfectly round (e.g., as it would look from an oblique imaging angle). Parameter-based and feature-based imaging requirement can be mixed—e.g., a camera pose offset may be parametrically specified relative to a feature-based camera pose definition. For an open inspection requirement, whether the imaging requirement is parameter-based or feature-based depends on the inspection procedure 207.

Furthermore, it is described hereinabove that a feature-based imaging requirement can furthermore be a functional imaging requirement. This is evaluated, in some embodiments of the present disclosure, by actually using an image in an inspection procedure 207 (e.g., as described in relation to FIG. 2E). In this case, the provided imaging requirement 103 may itself comprise a description of and/or reference to a certain inspection procedure 207. Success/failure of the inspection procedure 207 is an indication that the imaging requirement is fulfilled.

The arrows of FIG. 2B reflect, for example, the following set of optional relationships implemented in some embodiments of the present disclosure:
A product model 205 may provide parameters which sufficiently supply the undefined parameters of an inspection procedure 207 to allow generating corresponding imaging requirements 103.
Semantic identifications of features (e.g., components) of the product model 205 are optionally processed as “triggers” to associate those features with appropriate inspection requirements 101. The product model 205 furthermore specifies the positions of components, which may be used to help generate imaging requirements.
Inspection procedures 207 may be referenced by inspection requirements 101, allowing imaging requirements 103 to be extracted that relate to fulfilment of the inspection requirements 101.

### Location-Linked, Non-Image Inspection Products

Reference is now made to FIG. 2C, which schematically illustrates the determination of correspondences between non-image inspection work products and inspection requirement through correspondences in position, according to some embodiments of the present disclosure. In some embodiments, the determined correspondences are used as part of inspection planning by an automated inspection planning system.

In outline, the main actions of the determination of correspondences comprise:
at block 230, in some embodiments, mapping an inspection result provided as part of a location-tagged inspection product 107a to a location characterized more directly in terms useful to the inspection planning system, using one or more of images 107 and design documentation 110; and
at block 232, in some embodiments, matching that location to a location associated with a location requirement 103a, thereby establishing a further correspondence between the requirement part of the location requirement 103a and the result of the location-tagged inspection product 107a.

The location-tagged inspection product 107a comprises an inspection product for which some kind of location data is known and/or determinable by the inspection planning system. However, the location data that the inspection planning system can usefully access is potentially incomplete; in the sense that the inspection planning system cannot determine exactly what inspection target was being inspected, using the location-tagged inspection product alone. Additionally or alternatively, inspection target location may be tagged, for the inspection planning system, through another type of data recognizable to the inspection planning system (e.g., as a component identifier and/or part number). Nevertheless, in some embodiments, the inspection planning system is naïve about additional data accompanying the location tag, e.g., unaware of how to fully interpret inspection results encoded in the inspection product 107a.

This is a situation which could arise for the case where an inspection planning system is being operated in an already established inspection environment that has been operating according to some set of standards which, at least in their totality, the inspection planning system is unable to interoperate with. It is possible, nonetheless, that a work product of the established inspection environment contains spatial data in the form of geometrical coordinates, and/or identifiers, which the inspection planning system can map to its own representation of the inspected item and its configuration. The mapping may comprise, for example, parsing output markup, for example a dialect of XML, for common labels and tags which indicate spatial coordinates. Additionally or alternatively, the mapping may comprise selecting one or more column in tabular output which appear to correspond to position data and/or identifier data. In effect, the inspection product is optionally reduced, for the purposes of the inspection planning system, to certain of its more generic data elements.

With this done, however, there may remain the question—what do those spatial coordinates and/or identifiers signify for the work of the inspection planning system? In some embodiments, the significance is determined by using additional information to map the coordinates and/or identifiers to particular elements (e.g., components) of an inspected item, at block 230.

With an additional assumption such as “whatever is at the coordinate point was inspected” or “whatever has this identifier was inspected” the inspection planning system can then proceed to build a plan which takes this into account.

The planning is performed at block 232. In some embodiments, the planning comprises noting which requirements that the inspection system knows about are expected to be fulfilled at locations which it determines some other inspection resource has performed an inspection on. The inspection planning system may be configured to recognize which types of requirements that inspection would have fulfilled, or optionally simply treats the target as having been adequately inspected. Optionally, specification and/or limitation of what general characteristics could have been inspected is implemented by a user selection from a set of predetermined options.

In some embodiments, knowing the target may allow more detailed use of the location-tagged inspection product. For example, the inspection planning system may be able to access a “pass or fail” column of an inspection report which contains easily interpreted binary-valued test results. Knowing from its own matching work what element was actually inspected, allows extraction not only of the fact that an element is inspected, but also the result of that inspection. Optionally, the persistence of an element in the manufacturing chain after some inspection has been carried out is treated as sufficient evidence that it has passed inspection.

In some embodiments, the operations of block 230 are carried out using images 107. Images 107 are optionally as described in relation to FIG. 1. They may be, for example, images produced by visual inspection equipment as part of their operation, but not according to a plan which originates with the automated inspection planning system. In some embodiments, the situation is rather the reverse: the automated inspection planning system is performing operations of FIG. 2C in order to determine what inspection requirements do not need to be satisfied by additional planning. Other use scenarios for the determined correspondence are described, for example, in relation to FIG. 4.

In the case of the method of FIG. 2C, the one or more images 107 are optionally used in some embodiments of block 230 to help determine what elements (e.g., components of an assembly) are likely to have been the inspection targets of the inspection products 107a.

In some embodiments, images 107 are image products which were also the basis of the other location-tagged inspection products 107a. In this case, the coordinate system of the location-tagged inspection product 107a may be the same as the coordinate system of the image 107. This can simplify the matching of inspection product results to locations that the inspection planning system can interpret. An element in the image 107 that the inspection planning system can identify by any means (e.g., machine learning pattern recognition) gives, through its location in the image, a location corresponding to location requirements 103a associated with that element; and the same location can be directly compared to locations in the location-tagged inspection products 107a.

In some embodiments, image 107 (if available) does not directly provide the coordinate system of the location-tagged inspection produce 107a, but rather serves to indicate a coordinate system which through some transformation can be matched to the coordinate system used by location-tagged inspection products 107a. Additionally or alternatively, there may be provided design documentation 110, which can be parsed by the inspection planning system to determine coordinates of elements (e.g., components) that set the locations of location requirements. Additionally or alternatively, identifiers and/or properties specified by design documentation 110 are directly mapped to matching identifiers and/or properties discovered in the location-tagged inspection products 107a. In either case, some transformation can be understood to link the positions/identities of elements as determined by the design documentation to positions/identities as represented by the location-tagged inspecting products.

If a spatial coordinate transformation is not otherwise known, it can be determined, in some embodiments, e.g., by an error minimizing algorithm that calculates distances between transformed coordinates and target coordinates for a plurality of transforms, and iterates while modifying the transforms to minimize distance (minimize error in the transformation). A selected transformation then becomes part of the mapping of results-to-locations-to-requirements, allowing the inspection planning system to understand not just that something at some coordinates was inspected, but more particularly what at those coordinates was inspected.

### Tokenized, Non-Image Inspection Products

Reference is now made to FIG. 2D, which schematically represents determination of correspondences between inspection work products and inspection requirements through use of tokens, according to some embodiments of the present disclosure. In some embodiments, the determined correspondences are used as part of inspection planning by an automated inspection planning system.

Additionally or alternatively to identifying generically encoded information already in an inspection work product; in some embodiments, encoding can be added to or alongside the work product, in order to make its meaning at least partially interpretable to an inspection planning system that is not configured to fully interpret the work product itself.

Within the dynamic context of a factory floor inspection resources which operate according to configurations outside the control of the inspection planning system may change what they are inspecting, how they are inspecting it (e.g., in the case of manual configuration adjustments), and even whether they are doing it (e.g., in case of an equipment failure). Furthermore, staff may not be available with the skills and/or time to perform detailed reconfiguration of an inspection planning system in response to changes in the overall inspection environment. Accordingly, there is a potential benefit to providing one or more “side-channel” methods of communicating information to the inspection planning system which it can interpret in order to dynamically adjust the inspection plans it produces.

There may be a potential benefit for such a communication channel also in other conditions; e.g., to ease the task of integration of an inspection planning system into an existing inspection environment.

In some embodiments, the communication channel is established by “tokenizing” both an inspection requirement 103b, and a corresponding inspection work product or aspect thereof. From the point of view of the inspection planning system, the token may be any physical or data object that, simply by being detected, allows the inspection planning system to include assumptions about which tokenized requirements 103b are already being fulfilled with the inspection environment that is outside of its direct knowledge or control. In some embodiments, the token is designed to carry additional information which the inspection planning system is configured to use (e.g., bar codes and/or uniform resource locator strings).

At block 108, inspection products 108 are shown. These can be any product produced by an inspection. Two broad types of tokenization are indicated, in the form of indirect tokenization 242, and direct tokenization 240.

Direct tokenization 240 comprises using the inspection product itself, or an inherent result of it, as a token of an inspection result. For example, a file with a certain path and/or naming pattern may appear on a networked computer storage directory upon the completion of a certain inspection routine. The inspection planning system may be configured to recognize that file as indicative of some suite of inspection requirements having been fulfilled (or not).

In some embodiments, the inspection planning system is instructed to recognize the continued presence of an assembly in the manufacturing chain as “evidence” of previous successful quality checks; another form of direct tokenization 240. For example, subassemblies received from an outside vendor may be subject to acceptance testing. Thus, the very presence in some later stage of manufacturing assembly can be treated as evidence that at least some portion of the requirements which the inspection planning system is aware of for that subassembly are satisfied.

Block 242 represents another path for tokenization: “indirect” tokenization of inspection products 108. In some embodiments, this may comprise the use of a sticker, label, or other object that accompanies an inspected item as it travels, or on the inspection product itself, e.g., where the inspection product comprises printed material or another indication of inspection results. The object may be one that is provided specifically for identification by the inspection planning system and/or inspection resources it controls, or it may be a token which is anyway added in the course of inspections, e.g., as part of tracking procedures already in place

Block 107a indicates the tokenized inspection product(s) which are either substantially identical to the inspection produces themselves (in the case of direct tokenization), or associated with the inspection products, e.g., via association to the particular inspected item.

At block 244, in some embodiments, tokens are mapped to corresponding tokenized inspection requirements 103b. In some embodiments, “tokenization” of a tokenized requirement 103b comprises making it conditional on the presence of the token (and optionally additional information it may carry) at some juncture of inspection planning, and/or the carrying out of the inspection plan itself. The inspection planning system may use the token to turn off or turn on the performing of inspection actions it plans, or optionally perform the inspection action differently, e.g., with more or less thoroughness.

In some embodiments, for example, banks of one or more inspection requirements are turned on or off for the inspection planning system according to the token indicating operation of an inspection resource which is introduced sporadically to an inspection environment; e.g., as it becomes opportunistically available due to occasional periods of underutilization in the inspection of some other inspected item.

In some embodiments, the token is used to assist load balancing in conjunction with inspection resources outside the control of the inspection planning system. For example, if an uncontrolled inspection resource is overloaded, some items of manufacture may bypass it. This results in failure to generate the token that indicates fulfilment of certain inspection requirements; or, alternatively, generation of a token that indicates their lack of fulfilment. The inspection planning system can plan for certain inspection actions to be performed in this condition which supply the missing inspection actions. Additionally or alternatively, it can omit performing inspection actions which only “make sense” if the earlier inspection actions had been carried out normally—for example, the token can be used to ensure that null results are not misinterpreted as actual failures.

In some embodiments, a token is introduced sporadically to trigger additional testing when the results of a first stage of inspection testing (by an uncontrolled inspection resource) are ambiguous, incomplete, or suggest that some requirement is violated (e.g., because a non-specific test failed, such as a subassembly having the wrong weight) without necessarily fully identifying the requirement that caused the exception.

In some embodiments, an established procedure in an inspection environment may comprise handling a change in production conditions by adjusting a setting on an inspection resource outside the control of the inspection planning system itself. For example, a demand for greater inspection throughput may be met by reducing some aspect of quality inspection testing; conversely, there may be a greater demand on inspection thoroughness at certain times, for example, just after a factory floor has resumed production, just after a new piece of equipment is installed, or for another reason. Rather than adjusting the established procedure (resulting, e.g., in a need to retrain staff), it may be preferable to configure the inspection planning system to detect this condition as a “token” (e.g., according to some feature of the inspection products such as file naming pattern, file time stamps, and/or file time stamp intervals), and adjust accordingly.

File time stamp intervals (corresponding to intervals of time between inspections of individual items of manufacture) are optionally used as a token indicative of pending load and/or backlog for an inspection planning system. In some embodiments, inspection actions are tuned by the inspection planning system so that its own actual or anticipated throughput is adjusted based on the inspection load which is to be processed.

### Determination of Image-to-Requirement Correspondences

Reference is now made to FIG. 2E, which is a schematic diagram of inputs and outputs to a method of evaluating images for their usefulness in fulfilling imaging requirements, according to some embodiments of the present disclosure. Reference is also made to FIG. 2F, which schematically illustrates operations in the method of FIG. 2E, according to some embodiments of the present disclosure.

In FIG. 2E, images 107, their associated (and optional) image parameters 105, inspection procedures 207, product model 205, and inspection requirements 101 are all defined and provided generally as described in relation to FIGS. 1-2B.

More particularly, product model 205 is defined, in some embodiments, to comprise a plurality of inspection targets 206. The inspection targets 206 are in turn defined at least by type (e.g., semantic identification) and position. Optionally, there is also a geometric representation of the inspection targets 206 in the product model 205. In the schematic of FIG. 2E, inspection requirements 101 are linked particularly to respective inspection targets. Linkage to inspection requirements may be implied (as semantic information) by the semantic identification of the inspection target. Optionally, the inspection requirements are supplemented, modified, or “pruned”—manually, or on the basis of other information such as quality requirements imposed by the manufacturing environment more generally.

At block 209, these inputs are used (for a particular inspection target 206) as outlined in the blocks of FIG. 2F:

At block 220, in some embodiments, procedures from inspection procedures 207 are selected. Selection is made according to which of the known (system-defined) inspection procedures 207 are appropriate to fulfill the inspection requirements 101 of the inspection target 206. “Appropriateness” may be encoded, for example, by use of identifier referencing between inspection procedures and inspection requirements (the procedure references the inspection requirement, and/or the requirement references the procedure). In some embodiments, a matching module familiar with properties of both inspection requirements and inspection procedures makes the determination that a certain inspection procedure may be performed to fulfill all or part of a certain inspection requirement.

At block 222, in some embodiments, images 107 are selected which are candidates for showing the inspection target 206. While in principle this selection could include any of the available images, it is a potential advantage to narrow selection to candidate images which were obtained according to image parameters 105 which potentially placed inspection target 206 in view of the camera. This can help, for example, to prevent false matching (e.g. with another inspection target of the same type), and reduce fruitless use of processing resources.

At block 224, in some embodiments, the selected inspection procedures 207 are performed on the selected instances of images 107, with respect to the current inspection target 206. This produces inspection test result 208. The inspection procedure can be any image-based machine-implemented test.

Nonetheless, some such tests may be more indicative of the utility of the image for performing inspections than others, as next discussed.

From the point of view of the method of FIGS. 2E-2F, the implementation of the inspection procedure may be taken as a “black box” that accepts images as an input, and produces pass/fail as an output (with a few caveats and enhancements, for example as mentioned below). For example, a generic inspection procedure can be conceptualized as a computerized algorithm which accepts one or more inspection images along with optional configuring parameters as inputs, algorithmically processes the images with respect to image regions representing some inspection target, and provides, as output, a result which indicates whether the inspection target passes the procedure or not. There is no particular constraint on how the result is arrived at. Optionally, for example, the algorithmic processing is explicitly defined with respect to low-level image features (e.g., checking an image distance between local peaks in pixel values located in predefined portions of the image). Additionally or alternatively, algorithmic processing may be performed using a machine learning product trained on examples so that it discriminates flawed from non-flawed samples based on weightings established by the training procedure.

The interpretation of result 208 may vary according to the outputs of the inspection procedure and inspection conditions. Potentially (in a caveat to the “black box” assumptions), the principles by which the inspection procedure operations may also have an effect on result interpretation.

In some embodiments, a positive test result is taken to mean that the inspection target appears in the image with a size, orientation, lighting, and/or other parameters that allow it to be usefully tested. Accordingly, the image corresponds to whatever imaging requirement role it filled as part of the inspection procedure. Assuming a good-quality sample, a negative test result may mean the opposite (no correspondence). This meaning also assumes that the test operates on a principle of being selective for a good quality target as such, rather than being selective for the presence of a negative quality issue (that is, a flaw detector).

As an example of the difference: a surface may be required to have a certain uniform texture; if an inspection procedure sees that texture in an image, then the image can reasonably be assumed to be useful for inspection. Conversely, a failure to see a scratch (by an inspection procedure that is basically a scratch detector) might be due to a blurred (and not useful) image, rather than an actual absence of scratches. To accommodate such flaw-selective tests, the sample of the inspected item is optionally modified (e.g., damaged) to display the flaw. In this case, a negative rather than a positive test result is expected.

In some embodiments, an inspection procedure may itself perform checks that validate its inputs, and/or yield error conditions when inputs fail to produce expected results (positive or negative). Error and/or failed validation outcomes are optionally interpreted as indications that an image is not in correspondence with the imaging requirement role for which it was tested.

Some inspection procedures optionally produce a confidence indication as well as the result itself. In some embodiments, a criterion for correspondence is optionally used that not only should the correct (expected) inspection procedure result be produced, but also produced to a certain level of confidence; e.g., above a threshold of some confidence metric.

Optionally, the inspection procedure is performed multiple times. Optionally, the multiple inspection procedure performances use different images (which may share the same image parameters) for the same imaging requirement role. Optionally, the multiple inspection procedure performances are performed on different samples of the inspected item. Optionally, the different samples include both flawless and flawed examples with respect to at least one of the inspection targets. Analysis of the population of inspection procedure performances (e.g., statistics and/or consistency of results) may be used to determine whether images taken according to certain imaging parameters are in sufficient correspondence to a certain imaging requirement.

### Examples of Camera Configurations

### Fixed and Limited-Mobility Cameras

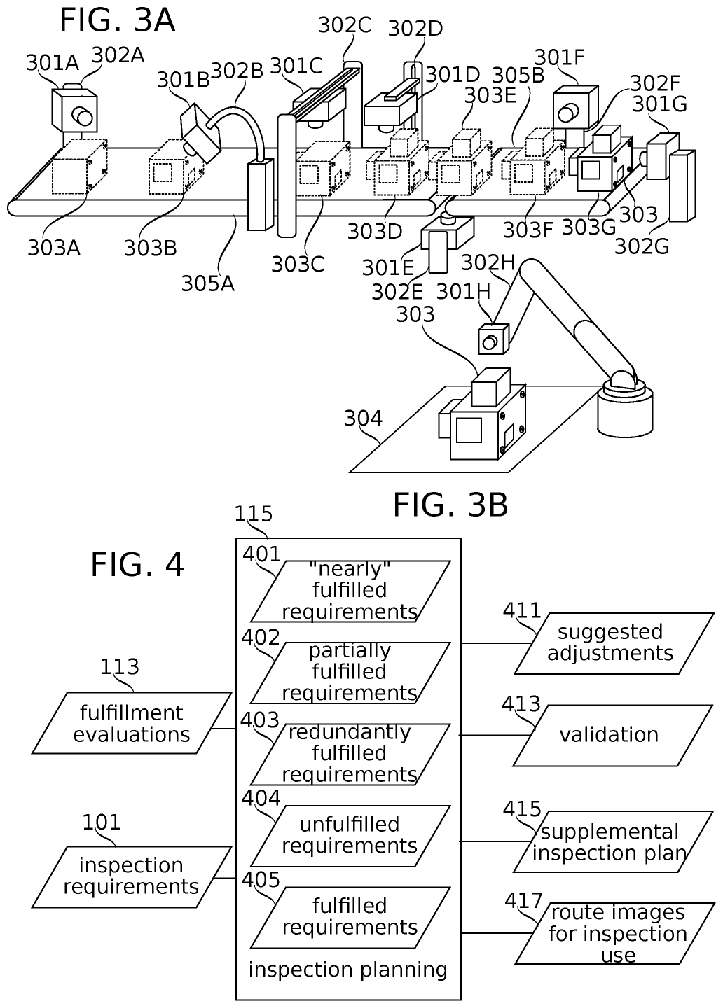

Reference is now made to FIG. 3A, which schematically illustrates a multiple-camera inspection line, comprising a plurality of cameras 301A-301G which image an inspected item 303 at different stages 303A-303G of its assembly, according to some embodiments of the present disclosure. For the purposes of description, stations of the inspection line/assembly line are depicted arranged along a pair of conveyors 305A, 305B; but it should be understood that embodiments of the present disclosure are not limited to any particular spatial relationship of inspection stations, or any particular method of conveyance of items of manufacture between inspection stations.

The following descriptions of the configuration shown in FIG. 3A give an impression (and not an exhaustive list) of the great variety of configurations of imaging parameters which may occur along an inspection line. Some imaging parameters may be unknown, or vaguely defined, while others may be well characterized.

Cameras 301A, 301B, 301E, 301F, 301G are each mounted to a stationary mount 302A, 302B, 302E, 302F, 302G. Cameras 301C and 301D are each mounted to a respective movable mount 302C, 302D. In each of these two cases, a single degree of freedom is illustrated, but it should be understood that 2, 3, or more degrees of freedom are optionally provided. Cameras may be rectangular-frame type cameras (e.g., camera 301A), or line scanning cameras (e.g., camera 301E, scanning through the gap between conveyors 305A, 305B). Cameras may be color, black and white, and/or sensing outside the human-visible spectrum. Beyond these image parameters, there are parameters comprising the particular angle, distance, and focus from which each camera views the inspected item 303 at one or more of its stages of assembly 303A-303G. The stages of assembly may be conceptualized as lying along a “time” degree of freedom (time increasing from left to right). A single continuous process of assembly is depicted, although assembly may take place in a plurality of separately built assemblies which are then assembled to each other. In some instances (e.g., for cameras 301E, 301F, 301G), the spatial relationship of the camera to the inspected item 303 at the moment of imaging may be well-defined. In others (e.g., for camera 301B mounted on a flexible neck 302B), this spatial relationship may be known only approximately. In some instances, the spatial relationship may not be known at all, apart from what can be learned by analyzing the image (e.g., if there is a randomization of the orientation of the inspected item 303 at some camera station).

Relating to the stages 303A-303G of assembly, some features are only visible at an earlier stage of assembly. For example, part of the top surface seen at stage 303C is visible to camera 301C, but hidden for all subsequent cameras 301D-301G due to the progress of assembly. Conversely, parts added later in assembly (such as the block added at stage 303D) are not in view for earlier camera stations. Whatever the stage of assembly, cameras may be configured to view only certain sides of the inspected item, and optionally only portions of certain sides.

Considering potential variety of imaging stations in both configuration and capability (e.g., including in aspects just outlined), it may be understood that there is a problem for automatic inspection planning of how to incorporate disparate inspection resources comprising cameras and associated operating devices into a scheme that can be matched to the visual inspection requirements which are defined for a certain inspected item. In some embodiments of the present disclosure, this problem is addressed by transformations from one or both of the camera side and the requirements side that allow images and/or imaging parameters to become the meeting point of the two sides. Inspection requirements for particular inspection targets are converted to imaging requirements, while inspection resource configurations are considered in terms of images themselves and/or a potentially incomplete set imaging parameters which constrain how those images are taken. To establish corresponds between images and imaging requirements, sample images may be evaluated directly in terms of their utility for performing inspection procedures (e.g., as described in relation to FIGS. 2E-2F), and/or imaging parameters may be compared.

### Multi-Axis Robotically Controlled Cameras

Reference is now made to FIG. 3B, which schematically illustrates an inspection station comprising a camera 301H on a multi-axis robotic mount 302H, according to some embodiments of the present disclosure.

Compared to camera configurations discussed in relation to FIG. 3A, a multi-axis robotically mounted camera system provides potential advantages for flexibility of camera pose selection when generating an inspection plan. From a position at a single imaging station comprising camera 301H and robotic mount 302H, inspected item 303 can be seen from almost any angle that a visual inspection requirement demands (apart from interference potentially imposed by the presence of supporting platform 304). Furthermore, the controller of a multi-axis robotic controller will typically fully define camera positions in every relevant parameter.

However, there are further potential advantages which may be realized by combining multi-axis camera positioning via a robotic manipulator with the capabilities of relatively less flexibly positionable (or even fixed) cameras. For example, there are potential inefficiencies in bringing the partially assembled inspected item 303 to the station of robotically positioned camera 301H (or vice versa) after each critical stage of assembly. Duplicating a robotically positioned camera 301H at all or several of the positions of cameras 301A-301G is likewise potentially inefficient, e.g., in terms of equipment cost, use of manufacturing space, and/or effect on the flow of assembly steps.

### Integration of Different Camera Types

A few examples will now be described of ways in which the use of robotically mounted camera 301H is potentially improved by integration with image results obtained by one or more of cameras 301A-301G of FIG. 3A.

Of the cameras described, camera 301E is uniquely positioned to image the underside of inspected item 303 (and furthermore, nothing is done to change the underside subsequent to this imaging). This is a potential advantage for camera 301H, since it solves the problem of an inaccessible underside due to the presence of supporting platform 304. This may reduce or remove a need for repositioning of inspected item 303 itself during robotic inspection using camera 301H.

Noting further that the overall configuration of cameras in FIG. 3A comprises many cameras at many positions, it is furthermore a potential advantage to automate the process of identifying which image(s) (and corresponding camera(s)) can supply otherwise inconvenient underside images.

Taken together, cameras 301F and 301G are positioned to obtain full views of two additional sides of the final assembly of inspected item 303. By taking this into account, an inspection plan for operating robotically mounted camera 301H can optionally reduce the number of images which need to be taken at its station. This potentially results in faster throughput, and a corresponding reduction in the cost of quality imposed by a thorough final visual inspection.

Any of cameras 301A-301G may have originally been configured up to take images for one or more particular inspection requirements, or even configured to take images from views that seem important, without a particular inspection requirement in mind. The requirement, if any, may be one known (provided) to the process of planning inspection using robotically mounted camera 301H), or it may be unknown (ignored, or not provided). With respect to any imaging requirement known to the correspondence-determining functions of an automatic inspection system, a certain image which is supposed to fulfill that requirement can be validated for whether or not it does fulfill that requirement.

It is noted that the above uses may be made of images from cameras other than camera 301H, even without any reconfiguration of their imaging parameters.

Optionally, any of cameras 301A-301G is “virtually” configured, e.g., provisionally defined during planning of the overall inspection line, and provided as imaging parameters even though no actual camera has been so-positioned. Optionally, images are simulated as if taken from these simulated positions, or even actually mimicked using a different camera, for example, robotically mounted camera 301H.

In any of these cases, as well as cases where cameras have been previously configured, images and/or imaging parameters can be evaluated, not only for which imaging requirement(s) they may be in correspondence with, but also for which imaging requirement(s) they are almost in correspondence with (which imaging requirement(s) they “nearly” fulfill). Optionally, determinations of such near-correspondences are propagated back from the determining of correspondences in block 109 of FIG. 1 to adjust or suggest adjustments to imaging parameters 105. Adjustments can optionally take into account other correspondences that have been determined, so that adjustments to better fulfill one imaging requirement don't destroy the fulfilment of another one.

Optionally, during planning of motions of robotically controlled camera 301H, it may arise that certain imaging requirements are expensive (e.g., in terms of time) or otherwise present difficulties. For example, they may require camera 301H to travel to a position distant from any other position it visits, making that single image expensive in terms of inspection time. Camera 301H may need to travel to a position which is awkward (e.g., located in and/or looking into a confined space), and/or travel in order to image an inspection target which is difficult to illuminate clearly. In these cases, selection of imaging parameters 105 for some images 107 (FIG. 1) may be driven by planning of robotic camera movements, in order to provide cheaper and/or more robust inspection.

The examples just described in relation to FIGS. 3A-3B have emphasized the integration of a relatively flexible inspection camera positioning system (e.g., the robotically mounted camera of FIG. 3B) with a disparate collection of cameras (e.g., of FIG. 3A) configured with relatively inflexible positioning capabilities. However, it is not necessary to focus on the optimization of just one visual inspection resource with respect to all the other visual inspection resources. In some embodiments, there is no robotically controlled camera at all. In some embodiments, there may be a plurality of robotically controlled cameras, each optionally situated to obtain images during a different stage of assembly.

### Inspection Planning Use Cases

Reference is now made to FIG. 4, which schematically outlines examples of use cases within which the method of FIG. 1 may be performed, according to some embodiments of the present disclosure. With respect to FIG. 1, inspection planning 115 was mentioned as a single block. FIG. 4 analyzes inspection planning 115 to a number of different considerations and optional outputs.

In some embodiments, the cameras of an inspection line (however comprised; and optionally all existing, or simulated in whole or in part) are evaluated in terms of the images they produce/are expected to produce, and/or the imaging parameters which control those images. The evaluation comprises comparison to imaging requirements to identify correspondences between the imaging requirements and images each camera will obtain. As described, for example, in relation to FIG. 1, fulfilment evaluations 113 are generated which relate the fulfilment of imaging requirements 103 back to the original inspection requirements 101 that gave rise to them.

In some embodiments, FIG. 4 relates additionally or alternatively to non-image inspection results; for example, wherein fulfilment evaluations are performed on the basis of mapping a spatially-indexed inspection product to features of a design based on images or design documentation (e.g., as described in relation to FIGS. 2C), and/or wherein fulfilment evaluations are performed on the basis of tokens (e.g. as described in relation to FIG. 2D).

At least five different classes of inspection requirement fulfilments may optionally be identified, and inspection planning may proceed differently depending on the class.

Fulfilled inspection requirements 405 require no further action, except to ensure (block 417) that the correct images are routed to the correct inspection protocols during actual inspections.

Partially and completely unfulfilled inspection requirements 404, on the other hand, should be somehow satisfied.

This may be done, at least in part, by means of a supplemental inspection plan 415, which specifies additional images and how to take them. Generation of complete inspection plans has been described, for example, in International Patent Publication No. WO2016/083897, the contents of which are included herein by reference, in their entirety. Supplemental inspection plan 415 may be generated in the same way, but omitting imaging for inspection and/or imaging requirements which are already determined to be fulfilled.

Additionally or alternatively to a supplemental inspection plan 415, there may be provided suggested adjustments 411 to cameras whose images and/or imaging parameters produced the fulfilment evaluations 113. Modifying and simulating imaging parameters and/or images are also described in relation to FIGS. 3A-3B. For non-image inspection products, adjustments and/or alternatives are optionally produced if the inspection planning system recognizes inspection targets (e.g., based on analysis of spatial coordinate information in the non-image inspector product), and determines that it can itself fulfill related inspection requirements (at least, those it is itself aware of) using inspection resources under its own planning control.

“Nearly” fulfilled inspection requirements 401 refers, in some embodiments, to inspection requirements associated with one or more nearly fulfilled image requirements, in the sense described in relation to FIG. 3B. These near misses optionally perform a useful function by guiding changes defined in suggested adjustments 411. For example, rather than adding a new camera, a near miss to an imaging requirement may mean, where feasible, that an existing camera's parameters can simply be adjusted.

Supplemental inspection plan 415 may be understood as a special case of suggested adjustments 411, wherein supplemental inspection plan 415 leaves existing camera configurations unchanged, and instead adds at least one new camera and its configuration(s).

Any of the fulfilled or partially fulfilled requirements 405, 402 are potentially evidence of validation 413 of the inspection camera configuration, at least in part, particularly if actual images were used as part of determining image/imaging requirement correspondences, for example as described in relation to FIGS. 2E-2F.

Finally, redundantly fulfilled requirements 403 may point to the over-use of inspection resources. Suggested adjustments 411 may include suggestions to remove and/or reposition cameras which are performing overlapping roles.

System for Integrating Disparate Imaging Resources into Automated Inspection Planning

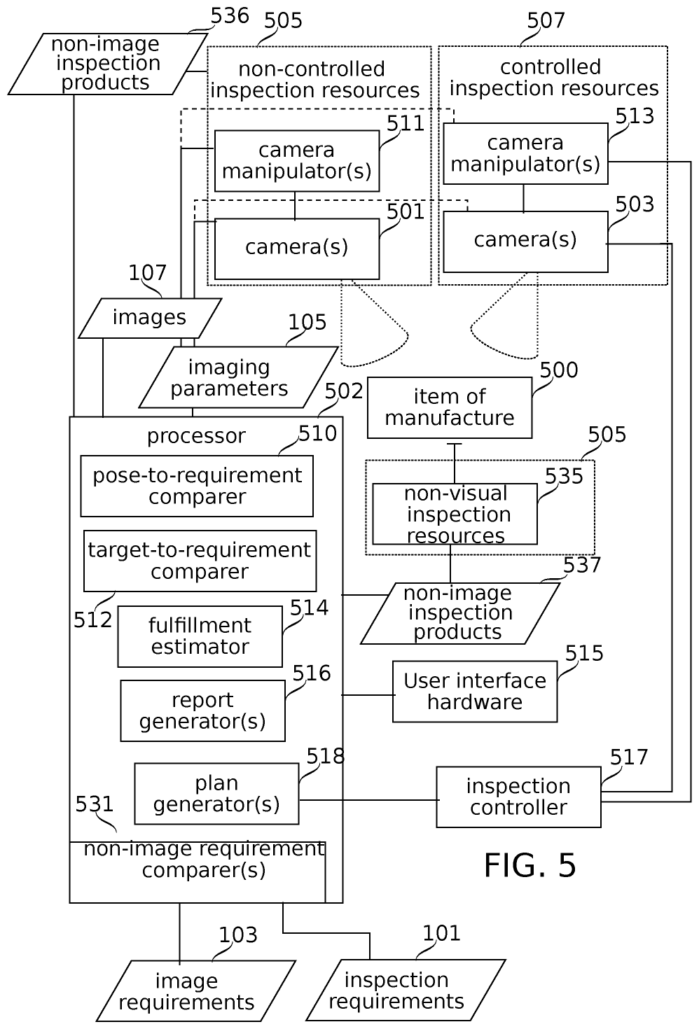

Reference is now made to FIG. 5, which schematically illustrates a system for integrating image outputs of disparate visual inspection resources into a visual inspection plan for a manufactured item, according to some embodiments of the present disclosure.

Inspection requirements 101 and imaging requirements 103 are as described, for example, in relation to FIG. 1, and with the same relationship to each other wherein the imaging requirements 103 derive from the inspection requirements 101.

Images 107 and imaging parameters 105 are sourced from non-controlled inspection resources 505, comprising one or more cameras 501 and optional corresponding camera manipulators 511. Non-controlled inspection resources 505 optionally include non-visual inspection resources 535; for example contact metrology devices which measure heights of components on subassemblies.

“Non-controlled”, in this context, refers to inspection resources 505 which are not directly configured and/or operated according to a plan generated by plan generator 518. For example, cameras 501 may be fixed-viewpoint devices (that is, fixed in camera pose relative to inspected item 500 during inspections), or devices which are manipulated during inspections to adjust their viewpoint according to privately configured commands.

In some embodiments, settings of a fixed or privately-configured device may optionally have been influenced by prior determinations of correspondences between images 107 they produce, and imaging requirements 103 generated from inspection requirements 101, but still escape direct control of the plan generator in the sense that there is lacking use of a machine communication interface by means of which instructions are received to image according to aspects of a plan generated by plan generator(s) 518. Similarly, the non-controlled inspection resources 505 are configured independently of commands given by inspection controller 517.

To the extent that the inspection-time movements of non-controlled inspection resources 505 are modified as a result of outputs from plan generator(s) 518 and/or report generator(s) 516, there is a “human in the middle” responsible for making the modifications.

Either or both of the types of non-controlled inspection resources 505 (cameras 501/camera manipulators 511; and non-visual inspection resources 535) may produce non-image inspection results 536, 537. The results 536, 537 may be, for example, of a type which contains generic data (e.g., spatial data, for example as described in relation to FIG. 2C). Additionally or alternatively, results 536, 537 are tokenized, for example as described in relation to FIG. 2D.

Controlled inspection resources 507, include cameras 503 and optional corresponding camera manipulators 513.

It is not strictly required that all of images 107 and imaging parameters 105 be sourced from non-controlled inspection resources. For example, a robotically controlled camera is optionally used to obtain images of an inspected item 500 which simulate images that would be produced by a correspondingly posed non-controlled camera. Such images may serve as a stand-in for feature-based evaluations, e.g., as described in relation to FIGS. 2E-2F.

In some embodiments, an inspection resource used to contribute images 107 and/or imaging parameters 105 is directly controlled by inspection controller 517 according to parameters provided over a machine interface, but limited and/or poorly defined in its control capabilities.

For example, a controlled camera 503 may move along only one axis, or be fixed but have the capability of being triggered to take an image at different times as an inspected item 500 moves relative to it. One way of handling such an inspection resource in inspection planning is to carefully specify it according to its range of capabilities, and then assign its use within those specified limitations. However, there may not actually be a clear capability specification available. For example, a camera may be able to move along an axis, but the axis itself may be oriented arbitrarily, e.g., on gimbals or using a gooseneck. Similarly, the track of an inspected item in motion within the field of view of a camera may be difficult to convert into a direct specification of relative position between the camera and the inspected item.

Rather than try to reverse engineer a capability specification by making geometrical and/or timing measurements of the apparatus supporting the camera, it may be more convenient, in some embodiments, to actually operate the camera manipulator within its range(s) of motion, take images at representative positions, and then use the camera in positions that those images demonstrate (e.g., in conjunction with methods described in relation to FIGS. 2E-2F) are useful to fulfill imaging requirements.

Processor 502 comprises an instruction executing unit and a memory which instructs the instruction executing unit to perform functions of one or more of the modules listed inside the block of processor 502.

Working separately or together, pose-to-requirement comparer 510 and target-to-requirement comparer 512 implement, in some embodiments, the determining of correspondence described in relation to block 109 of FIG. 1.

Pose-to-requirement comparer 510 is configured to perform aspects of determining correspondences wherein the imaging requirements 103 are at least partially specified as camera poses. Lighting aspects of imaging requirements 103 may also be included in correspondence determinations, e.g., angle, light source angular area, coloring and/or intensity of lighting. The imaging parameters, specified likewise as camera poses (optionally after evaluation of other inputs, e.g., as described in relation to FIG. 2A), are evaluated by pose-to-pose comparer 510 to determine if they are within the constraints of each relevant imaging requirement or not. There may be a plurality of pose-to-requirement comparer 510, e.g., each suited to requirements specified according to a different standard.

Target-to-requirement comparer 512 is configured to perform aspects of determining correspondences wherein the imaging requirements 103 are at least partially specified in terms of which inspection target is in view and/or its appearance. In some embodiments, target-to-requirement comparer 512 identifies the presence of targets within images, based on an image as such, and/or on imaging parameters which govern taking of the image. Target-to-requirement comparer may work jointly with pose-to-requirement comparer 510, and the two comparer may optionally be implemented as a hybrid comparer. Additionally or alternatively, in some embodiments, target-to-requirement comparer 512 performs functional tests on images to determine and/or verify that they are useful. The functional test can be a test of the image itself (e.g., based on a metric of image focus, lighting quality, and/or another parameter). In some embodiments, the functional test comprises performing an inspection protocol using the image, e.g., as outlined in relation to FIGS. 2E-2F. There may be a plurality of target-to-requirement comparers 512, e.g., each suited to requirements specified according to a different standard.

In some embodiments, one or more non-image requirement comparers 531 are provided; configured, for example to convert spatial coordinate data into an indication of which components have been inspected to produce a particular non-image inspection product, and/or to convert token indications into an indication of which components have been inspected.

Fulfilment estimator 514 is configured to carry out operations described in relation to block 111 of FIG. 1 related to estimating fulfilments.

Report generator 516 is an optional module which reports on fulfilments and/or correspondence determinations, optionally without going as far as actually planning inspection activities. The report may be used for tasks such as validating configurations of currently configured visual inspection resources, identifying flaws in their configurations, and/or determine changes to their configurations which may be more useful for performing a visual inspection procedures. The report optionally includes suggestions for changes, e.g., to convert “nearly” useful camera configurations into more useful camera configurations. There are optionally more than one report generator 516 implemented.

Plan generator 518 is an optional module which integrates outputs generated by the other processing modules (as well as other inputs, as necessary) in order to produce an inspection plan which makes use of relevant images produced by some combination of the non-controlled inspection resources 505, controlled inspection resources 507 which are incompletely characterized by their known configuration parameters, and controlled inspection resources (e.g., one or more robotically controlled cameras) which are available for use in fulfilling imaging requirements and/or inspection requirements left unfulfilled by the other types of visual inspection resources. With the addition of taking into account separately fulfilled imaging requirements and/or inspection requirements, plan generator 518 may be implemented, for example, as described in U.S. Pat. No. 10,916,005, the contents of which are included herein by reference, in their entirety.

Inspection controller 517 is configured to receive a plan from plan generator 518, and to carry it out at least in part by operation of controlled inspection resources 507. In some embodiments, imaging by non-controlled inspection resources is also part of the plan, but is carried out separately from the activities of inspection controller 517. Modules configured to carry out activities such as collation and storage of inspection results, evaluation of inspection results, inspection reporting, etc. may be integrated with the system of FIG. 5, but are not shown.

User interface hardware 515 may comprise any standard computer interface device such as a mouse, on-board camera, keyboard, touch screen, and/or display. Optionally, more specialized interfacing equipment is provided; for example, 3-D scanning and/or motion capture sensors.

### General

It is expected that during the life of a patent maturing from this application many relevant imaging technologies will be developed; the scope of the term “camera” is intended to include all such new technologies a priori.

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features except insofar as such features conflict.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

Throughout this application, embodiments may be presented with reference to a range format. It should be understood that the description in range format is merely for convenience and brevity and should not be construed as an inflexible limitation on the scope of descriptions of the present disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although descriptions of the present disclosure are provided in conjunction with specific embodiments, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

It is appreciated that certain features which are, for clarity, described in the present disclosure in the context of separate embodiments, may also be provided in combination in a single embodiment. Conversely, various features, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

1.-50. (canceled)

51. A method of integrating image outputs of pre-configured visual inspection resources into a visual inspection plan for an inspected item, the method comprising:
accessing, by a computer:
one or more imaging requirements derived from visual inspection requirements for the inspected item, and
imaging parameters specifying configurations of respective pre-configured visual inspection resources used to generate visual inspection images of the inspected item;
determining correspondences between the imaging requirements and the imaging parameters, each correspondence being established by:
a visual inspection image produced according to the imaging parameters shows an inspection target which is a portion of the inspected item, and
the inspection target is shown as specified by at least one of the imaging requirements;
estimating, using the correspondences, fulfilment of the imaging requirements by visual inspection images generated using the imaging parameters; and
generating a visual inspection plan fulfilling the visual inspection requirements, the visual inspection plan including the use of visual inspection images generated using the pre-configured visual inspection resources according to their respective pre-configurations.

52. The method of claim 51, wherein the determining correspondences comprises determination that:
imaging parameters for a visual inspection image specify a camera pose relative to the inspected item; and
the camera pose matches a camera pose defined by at least one of the imaging requirements.

53. The method of claim 51, wherein the determining correspondences comprises analyzing visual inspection images generated according to the specifying imaging parameters.

54. The method of claim 53, wherein the analyzing comprises mapping features of the visual inspection images to corresponding features of a 3-D model of the inspected item.

55. The method of claim 51, wherein:
each of the visual inspection requirements specifies:
at least one component to be inspected and
a visual inspection procedure testing the at least one component; and
the imaging requirements specify images of the at least one component used in the visual inspection procedure.

56. The method of claim 51, wherein:
the one or more imaging requirements each respectively specify at least one camera viewing angle of the inspected item;
the imaging parameters of each configuration respectively specify at least one camera viewing angle of the inspected item; and
the estimating comprises comparing camera viewing angles of the configurations to camera viewing angles of the imaging requirements.

57. The method of claim 56, wherein the estimating comprises determining if the camera viewing angles of the configurations are within one or more ranges defined by the camera viewing angles of the imaging requirements.

58. The method of claim 51, comprising categorizing the visual inspection requirements by the computer, based on the estimating by the computer; and providing the categorizations.

59. The method of claim 58, wherein the categorizing comprises identifying one or more of the visual inspection requirements as having none of the imaging requirements of its imaging requirement set fulfilled.

60. The method of claim 58, wherein the categorizing comprises identifying one or more of the visual inspection requirements as having all of the image input requirements of its image input requirement set fulfilled.

61. The method of claim 58, wherein the categorizing comprises identifying a visual inspection requirement as having image input requirements of its image input requirement set partially fulfilled.

62. The method of claim 61, comprising providing a specification of imaging parameters for additional visual inspection images of the inspected item that would complete fulfilment of said image input requirement set.

63. The method of claim 62, comprising:
accessing one or more first images from visual inspection images generated using the one or more imaging parameter sets, and which are images that partially fulfill the image input requirements of the image input requirement set;
accessing one or more second images from the additional visual inspection images; and
automatically analyzing the first and second images to fulfill the visual inspection requirement.

64. The method of claim 51, wherein the generating comprises generating an inspection plan specifying collection by a robotic imaging system of at least one additional visual inspection image, to complete fulfilment of at least one of the image input requirement sets.

65. The method of claim 51, comprising providing a specification of imaging parameters for inspection images that would complete fulfilment of at least one of the image input requirement sets.

66. The method of claim 65, wherein the imaging parameters define configurations of pre-configured visual inspection resources that include at least one of: one or more fixed-position cameras, and one or more cameras preconfigured to move along a predefined path.

67. The method of claim 51, wherein the estimating comprises:
accessing at least one image from visual inspection images generated using the one or more imaging parameter sets;
automatically analyzing the at least one image according to a visual inspection requirement;
evaluating validity of a result of the automatic analyzing; and
producing an estimate of the fulfilment of the imaging requirement depending on the validity of the result of the automatic analyzing.

68. The method of claim 67, wherein an invalid said result corresponds to an estimate of non-fulfilment of the visual inspection requirement's respective image input requirement set.

69. A method of integrating image outputs of visual inspection resources into a visual inspection plan for an inspected item, the method comprising:
accessing, by a computer:
one or more imaging requirements derived from visual inspection requirements for the inspected item, and
images of the inspected item obtained by visual inspection resources;
determining correspondences between the imaging requirements and the images, each correspondence being established by:
an image shows an inspection target which is a portion of the inspected item, and
the inspection target is shown in the image as specified by at least one of the imaging requirements;
selecting images potentially useful for fulfilling at least one of the visual inspection requirements, using the correspondences;
using the selected images, calculating results of automated visual inspection procedures configured to fulfill the visual inspection requirements;
estimating utility of the selected images in fulfilling the visual inspection requirements, using the calculated results; and
generating, guided by the estimated utility of the selected images, a visual inspection plan fulfilling the visual inspection requirements, the visual inspection plan including the use of visual inspection images generated according to imaging parameters used to generate at least one of the selected images, and estimated to be useful in fulfilling the visual inspection requirements.

70. The method of claim 51, wherein said pre-configured visual inspection resources are positioned to image components of the inspected item at different stages of assembly.

71. A system comprising an instruction executing unit and a memory which instructs the instruction executing unit to:
access:
one or more imaging requirements derived from visual inspection requirements for the inspected item, and
imaging parameters specifying configurations of respective pre-configured visual inspection resources used to generate visual inspection images of the inspected item;
determine correspondences between the imaging requirements and the imaging parameters, each correspondence being established by determining that:
a visual inspection image produced according to the imaging parameters shows an inspection target which is a portion of the inspected item, and
the inspection target is shown as specified by at least one of the imaging requirements;
estimate, using the correspondences, fulfilment of the imaging requirements by visual inspection images generated using the imaging parameters; and
generate a visual inspection plan fulfilling the visual inspection requirements, the visual inspection plan including the use of visual inspection images generated using the pre-configured visual inspection resources according to their respective pre-configurations.
